(19) United States
(12) Patent Application Publication
(10) Pub. No.: US 2026/0016369 A1
(43) Pub. Date: Jan. 15, 2026

(54) OPTICAL APPARATUS, OPTICAL INSPECTION APPARATUS, OPTICAL INSPECTION SYSTEM, AND OPTICAL INSPECTION METHOD

(71) Applicant: KABUSHIKI KAISHA TOSHIBA, Tokyo (JP)

(72) Inventor: Hiroshi OHNO, Tokyo (JP)

(73) Assignee: KABUSHIKI KAISHA TOSHIBA, Tokyo (JP)

(21) Appl. No.: 19/259,002

(22) Filed: Jul. 3, 2025

(30) Foreign Application Priority Data
Jul. 9, 2024 (JP) 2024-110427

(51) Int. Cl. G01M 11/02

(52) U.S. Cl. CPC G01M 11/0278

(57) ABSTRACT

According to an embodiment, an optical apparatus includes a light emission portion; a light direction selection portion; and an image-forming optical element. The light emission portion is configured to emit a first light beam of a first wavelength spectrum including a first wavelength. The light direction selection portion includes a first light direction selection region and a second light direction selection region on or near a focal plane of the image-forming optical element. The first light beam incident on the first light direction selection region or the second light direction selection region is emitted as a light beam having a different optical characteristic according to the regions, and at least one of the regions includes a light direction changer that is configured to change a direction of the incident light beam to a different direction and emits the light beam.

### CROSS-REFERENCE TO RELATED APPLICATIONS

This application is based upon and claims the benefit of priority from Japanese Patent Application No. 2024-110427, filed Jul. 9, 2024, the entire contents of all of which are incorporated herein by reference.

### FIELD

Embodiments described herein relate generally to an optical apparatus, an optical inspection apparatus using the optical apparatus, an optical inspection system using the optical inspection apparatus, and an optical inspection method.

### BACKGROUND

Contactless inspections of objects have become important in various industries. As a conventional inspection method, there is a method by which a color (wavelength spectrum) of a light beam separated using a diffraction grating or a wavelength filter is made to correspond to a light beam direction on a one-to-one basis, the color is specified to identify the direction of the light beam, and information on the surface or inside of the object is acquired.

### BRIEF DESCRIPTION OF DRAWINGS

FIG. 1 is a schematic cross-sectional view of an optical apparatus according to a first embodiment.

FIG. 2 is a schematic cross-sectional view of a part of the optical apparatus in a state where a line-of-sight direction of an observer is along a direction in which a second light beam is specularly reflected by a smooth surface.

FIG. 3 is a schematic cross-sectional view of a part of an optical inspection apparatus of an optical inspection system in which the observer illustrated in FIG. 2 is changed to an imaging unit.

FIG. 4 is a flowchart of processing by the optical inspection system illustrated in FIG. 3.

FIG. 5 is a schematic cross-sectional view of a part of the optical apparatus in which a line-of-sight direction of an observer V is different from a direction in which a second light beam is specularly reflected in a case where an object surface is a smooth surface.

FIG. 6 is a schematic cross-sectional view of a part of the optical inspection apparatus of the optical inspection system in which the observer illustrated in FIG. 5 is changed to the imaging unit.

FIG. 7 is a flowchart of processing by the optical inspection system illustrated in FIG. 6.

FIG. 8 is a schematic cross-sectional view of an optical apparatus according to modification 1 of the first embodiment.

FIG. 9 is a schematic cross-sectional view of an optical apparatus according to modification 2 of the first embodiment.

FIG. 10 is a schematic cross-sectional view of an optical apparatus according to modification 3 of the first embodiment.

FIG. 11 is a schematic cross-sectional view of an optical apparatus according to a second embodiment.

FIG. 12 is a schematic perspective view of a phosphor of an optical apparatus according to modification 1 of the second embodiment.

FIG. 13 is a schematic perspective view of a phosphor of an optical apparatus according to a further modification of modification 1 of the second embodiment.

FIG. 14 is a schematic perspective view of a phosphor of an optical apparatus according to modification 2 of the second embodiment.

FIG. 15 is a schematic cross-sectional view of a phosphor of an optical apparatus according to modification 3 of the second embodiment.

FIG. 16 is a schematic cross-sectional view of a light emission portion and a phosphor of an optical apparatus according to modification 4 of the second embodiment.

FIG. 17 is a schematic cross-sectional view of a light emission portion and a light direction selection portion of an optical apparatus according to a third embodiment.

FIG. 18 is a schematic cross-sectional view of a light emission portion, a light direction selection portion, and an image-forming optical element of an optical apparatus according to a modification of the third embodiment.

FIG. 19 is a schematic cross-sectional view of an optical inspection apparatus according to a fourth embodiment.

FIG. 20 is a schematic cross-sectional view of a modification of an imaging unit of the optical inspection apparatus according to the fourth embodiment.

FIG. 21 is a schematic perspective view of an optical inspection apparatus according to a fifth embodiment from which a light emission portion is omitted.

### DETAILED DESCRIPTION

Hereinafter, embodiments will be described with reference to the drawings. The drawings are schematic or conceptual, and the relationship between the thickness and width of each portion, the ratio of sizes between portions, and the like are not necessarily the same as actual ones. In addition, even in the case of representing the same portions, their dimensions and ratios may be represented differently from each other in the drawings. In the present specification and each drawing, the same elements as those described above with respect to the previously described drawings are denoted by the same reference numerals, and detailed description thereof is omitted as appropriate.

An object of an embodiment is to provide an optical apparatus, an optical inspection apparatus having the optical apparatus, an optical inspection system having the optical inspection apparatus, and an optical inspection method, capable of illuminating an object with light beams emitted from a light emission portion while the direction of at least some of the light beams is changed to a different direction.

According to the embodiment, an optical apparatus includes a light emission portion; a light direction selection portion; and an image-forming optical element. The light emission portion is configured to emit a first light beam of a first wavelength spectrum including a first wavelength. The light direction selection portion includes a first light direction selection region and a second light direction selection region on or near a focal plane of the image-forming optical element. The first light beam incident on the first light direction selection region or the second light direction selection region is emitted as a light beam having a different optical characteristic according to the regions, and at least one of the regions includes a light direction changer that is configured to change a direction of the incident light beam to a different direction and emits the light beam.

In the present specification, light is a type of electromagnetic wave, and includes gamma rays, X-rays, ultraviolet rays, visible light, infrared rays, radio waves, and the like. In the present embodiment, light is visible light, and the wavelength is in a region of 400 nm to 750 nm, for example.

### First Embodiment

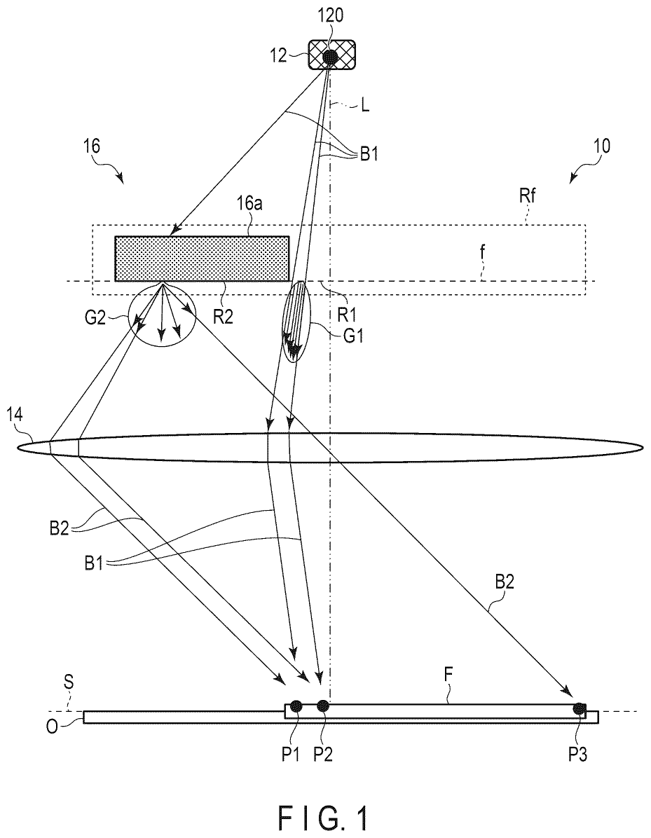

Hereinafter, an optical apparatus 10 according to the present embodiment will be described with reference to FIGS. 1 to 7.

FIG. 1 is a schematic cross-sectional view of the optical apparatus 10 according to the present embodiment. The optical apparatus 10 according to the present embodiment includes a light emission portion 12, an image-forming optical element (light condensing element) 14, and a light direction selection portion 16.

The light emission portion 12 includes a light source 120. The light source 120 is configured to emit a first light beam B1 of a first wavelength spectrum including at least a first wavelength. For example, the first wavelength is 405 nm, and the first wavelength spectrum has a peak at the first wavelength. Light having such a first wavelength spectrum will be referred to as blue light. However, the wavelength spectrum is not limited to this, and the wavelength spectrum of the light source 120 may be any wavelength spectrum. For example, the light of the light source 120 may be white light.

The light source 120 is a light-emitting diode (LED) that is configured to emit blue light. However, the light source 120 is not limited to this, and any light source may be used as long as it emits light. The light source 120 may be a laser diode (LD). Alternatively, the light source 120 may be sunlight, a plasma light source, a thermal radiation light source (incandescent lamp, halogen lamp, xenon lamp, and the like), or the like.

In the present embodiment, the light source 120 has a sufficiently small light emission surface that can be regarded as a point light source. However, the light source 120 is not limited to this, and the light source 120 may have a large light emission surface. If the light source 120 can be regarded as a point light source, light is emitted radially from one point. In particular, the thermal radiation light source can be made very small and can be regarded as a point light source in many cases.

The image-forming optical element 14 can form an image of light. The image-forming optical element 14 may be a single lens, a set lens including a plurality of lenses, a concave mirror, a Fresnel lens, a diffraction grating, a gradient index lens (GRIN lens), or the like, for example. That is, the image-forming optical element 14 may be any element as long as it can form an image of light. A plane on which a set of points at infinity is imaged by the image-forming optical element 14 will be defined as a focal plane f. The focal plane f and its vicinity will be referred to as a focal plane region Rf. An optical axis L of the image-forming optical element 14 is a straight line orthogonal to the focal plane f. Light emitted from a sufficiently distant point on the optical axis L is imaged at a point where the optical axis L and the focal plane f intersect. This point will be referred to as a focal point.

The image-forming optical element 14 of the present embodiment is a set lens including a plurality of lenses. This will be referred here to as an image-forming lens. However, FIG. 1 schematically illustrates an image-forming lens which is a set lens, as one lens, for the sake of simplicity. The image-forming optical element 14 is not limited to this, and may be any element as long as it forms an image of light. In the cross-sectional view of FIG. 1, the optical axis of the image-forming optical element is included in this cross section.

The light direction selection portion 16 includes a first light direction selection region R1 and a second light direction selection region R2 on or near the focal plane f of the image-forming optical element 14. That is, the light direction selection portion 16 has the first light direction selection region R1 and the second light direction selection region R2 in the focal plane region Rf.

The first light direction selection region R1 passes the first light beam B1 of the first wavelength included in the first wavelength spectrum while changing (altering) the optical characteristics of the first light beam B1 or without changing (altering) the optical characteristics of the first light beam B1. In the present embodiment, the first light direction selection region R1 passes the first light beam B1 as it is without changing the optical characteristics. A set of first light beams B1 facing different various directions from a point existing in the first light direction selection region R1 will be defined as a first light direction group G1.

The second light direction selection region R2 changes the optical characteristics of the first light beam B1. The optical characteristics here include a direction of a light beam, a wavelength, a wavelength spectrum, polarized light, luminance, illuminance, and a light flux (light amount).

The light direction selection portion 16 includes a light direction changer 16a in the second light direction selection region R2. The light direction changer 16a changes the direction of an incident light beam to change the light beam to a light beam in a different direction. The light direction changer 16a may be a light diffuser that diffuses light to direct light, and may be frosted glass, a holographic diffuser, a diffraction grating, or a phosphor, for example. The light direction changer 16a may be any of a transparent resin that has particles dispersed to scatter light, silk printing, paper, and the like. Alternatively, the light direction changer 16a may be anything that changes the direction of light, such as a microlens array or a fly-eye lens.

The light is diffused to produce at least two beams, including beams traveling in a direction different from the direction of incidence. That is, at least one light beam different from the incident light beam is newly branched. Even if the light is diffused by the diffuser 16a, the amount of light (total light flux) before and after the diffusion can be maintained. That is, the light can be diffused by the diffuser 16a without changing the light amount.

In the present embodiment, the light diffuser 16a is a holographic diffuser. When the light of the first wavelength spectrum passes through the light diffuser 16a, the wavelength spectrum does not change.

The object O may transmit or reflect light. Alternatively, the object O may be translucent. A point on the surface of the object O or inside the object O will be referred to as an object point. Hereinafter, unless otherwise specified, it is assumed that the object O reflects light, and the object point is present on the surface of the object. The surface of the object O may be referred to as an object face or an object surface S.

Next, the operations of the optical apparatus 10 of the present embodiment will be described.

Referring to FIG. 1, the light of the first wavelength spectrum is radially emitted from the point light source 120 of the light emission portion 12. The first light beam B1 is light of the first wavelength included in the first wavelength spectrum. The first light beam B1 travels toward the light direction selection portion 16 and reaches the first light direction selection region R1 or the second light direction selection region R2, or both.

The first light beam B1 having reached the first light direction selection region R1 passes as it is. A set of first light beams B1 passing through a point existing in the first light direction selection region R1 will be defined as the first light direction group G1. On the other hand, a second light beam B2 of a direction different from that of the first light beam B1 is newly generated by the diffuser 16a provided in the second light direction selection region R2. A set of second light beams B2 passing through a point existing in the second light direction selection region R2 will be defined as a second light direction group G2.

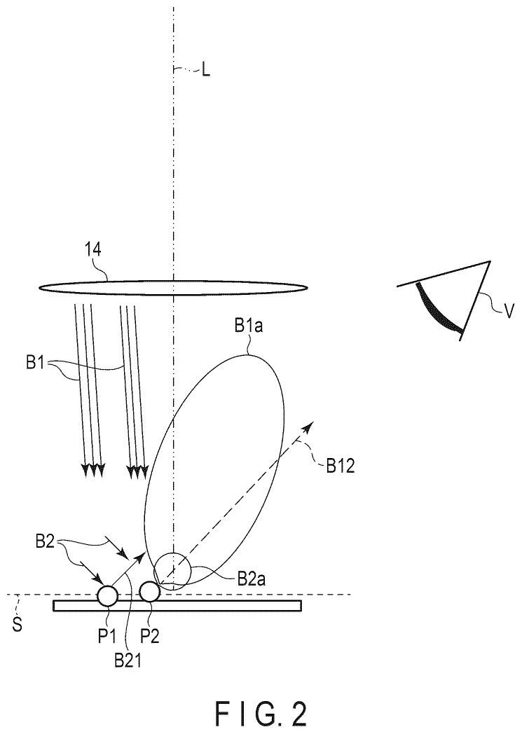

The first light direction selection region R1 and the second light direction selection region R2 are arranged on the focal plane f or near the focal plane f of the image-forming optical element 14, and are different from each other in position. Therefore, as illustrated in FIG. 2, the first light beam B1, which is one light beam of the first light direction group G1, and the second light beam B2, which is one light beam of the second light direction group G2, have different inclination angles with respect to the optical axis L when passing through the image-forming optical element 14. That is, based on the geometric optics, the inclination angle with respect to the optical axis L is determined according to the position where the light beam B1 passes through the focal plane f.

An irradiation field F is a region of the object surface S illuminated by the first light beam B1 or the second light beam B2, or both of the light beams B1 and B2. In the present embodiment, since the diffuser 16a exists in the second light direction selection region R2, there may be at least two points illuminated by both the first light beam B1 and the second light beam B2 in the irradiation field F. These points will be referred to as a first object point P1 and a second object point P2.

A case where the diffuser 16a does not exist in the second light direction selection region R2 will be discussed. In this case, all the light beam groups emitted from the point light source 120 are condensed at one point by the image-forming optical element 14. That is, the light beam groups emitted from the point light source 120 are imaged at one point that is an image of the point light source. Since the point light source 120 can be regarded as a point, its image can also be substantially regarded as a point. Therefore, no matter how the distance (working distance) between the image-forming optical element 14 and the object surface S is taken, only one point is simultaneously illuminated by the first light beam B1 and the second light beam B2, which is the image-forming point. That is, if the diffuser 16a is not provided in the second light direction selection region R2, the different first object point P1 and second object point P2 cannot be simultaneously illuminated by the first light beam B1 and the second light beam B2.

On the other hand, in the present embodiment, since the diffuser 16a is provided in the second light direction selection region R2, even if the light source is the point light source 120, the two different object points P1 and P2 can be simultaneously illuminated by the first light beam B1 and the second light beam B2. Accordingly, in the present embodiment, as compared with the case where the diffuser 16a is not provided, the wide irradiation field F including at least two object points P1 and P2 can be simultaneously illuminated by the first light beam B1 and the second light beam B2.

As illustrated in FIG. 2, a case where the irradiation field F is observed from a direction oblique to the optical axis L will be discussed. The object surface S is a flat surface. In the irradiation field F, the first object point P1 of the object surface S is present on a smooth surface. On the other hand, minute defects (minute asperities) exist at the second object point P2, and the minute defects widely scatter light. The line-of-sight direction of the observer is along the direction in which the second light beam B2 is specularly reflected by the smooth surface.

The second light beam B2 is generated by diffusing the first light beam B1 by the diffuser 16a in the second light direction selection region R2. That is, the second light beam B2 is obtained by branching the first light beam B1 by the diffuser 16a. Therefore, the luminance of the second light beam B2 is smaller than that of the first light beam B1.

First, reflected light from the first object point P1 will be discussed. The first light beam B1 is specularly reflected at the first object point P1, and reflected along the optical axis L. Therefore, the reflected light does not return to the observer V and is not observed. On the other hand, the second light beam B2 is also specularly reflected at the first object point P1, and reflected in a direction oblique to the optical axis L. Since the line-of-sight direction of the observer V is set along the specular reflection direction, reflected light B21 is observed. That is, the specular reflected light B21 from the second light beam B2 is observed by the observer V at the first object point P1 on the smooth surface.

Next, reflected light from the second object point P2 will be discussed. Since the minute defects exist at the second object point P2, both the first light beam B1 and the second light beam B2 are scattered by the minute defects and diffused (reflected) in various directions. That is, the light beams B1 and B2 incident on the minute defects are branched in various directions. Such a reflection characteristic can be described by a bidirectional reflectance distribution function (BRDF) representing the intensity of light for each reflection direction. The angular distribution of the light described by the BRDF becomes a narrow distribution having a specular reflection component as a main component in the case of a smooth surface, and becomes a wide distribution in the case of minute defects. In general, the BRDF of minute defects has a wide distribution around the specular reflection direction. The luminance of light beams B1a and B2a in each direction becomes lower than that at the time of incidence due to branching caused by scattering from the minute defects. That is, the luminance of the second scattered light B2a caused by scattering the second light beam B2 becomes low. Therefore, if the observer V observes only the second scattered light B2a, the second object point P2 appears dark. On the other hand, the observer V simultaneously observes not only the second scattered light B2a caused by scattering the second light beam B2 at the second object point P2 but also the first scattered light B1a caused by scattering the first light beam B1 at second object point P2. That is, the observer V observes a resultant component B12 of the first scattered light B1a and the second scattered light B2a. Since the luminance of the first light beam B1 is higher than the luminance of the second light beam B2, the luminance of the first scattered light beam B1a is accordingly higher than that of the second scattered light beam B2a. Therefore, the scattered light (first scattered light B1a) higher in intensity than the second scattered light B2a reaches the observer V. That is, the observer V can clearly observe the minute defects at the second object point P2.

On the other hand, if the luminance of the first light beam B1 is equal to or lower than the luminance of the second light beam B2, the intensity of the scattered light from the second object point P2 decreases, and the second object point P2 is observed to be dark by the observer V. Therefore, it is difficult to clearly identify the second object point P2. That is, the optical apparatus 10 according to the present embodiment has an advantageous effect of making the second object point P2 bright and clear.

As described above, if the object surface S is a smooth surface, there is an advantageous effect that the object points P1 and P2 can be observed by the second light beam B2. Further, if there are minute defects on the object surface S, the observer V simultaneously observes not only the second scattered light B2a caused by the second light beam B2 but also the first scattered light B1a caused by the first light beam B1. The first light beam B1 is higher in luminance than the second light beam B2. Therefore, there is an advantageous effect that the minute defects can be made bright and clear by the scattered light B1a caused by the first light beam B1. Accordingly, when the optical apparatus 10 is used, both the smooth surface and the minute defects become bright and can be clearly observed.

As described above, using the optical apparatus 10 according to the present embodiment has an advantageous effect that the surface state of the object O can be more reliably detected using the intensity information of the light in the wide irradiation field F including at least two different object points P1 and P2.

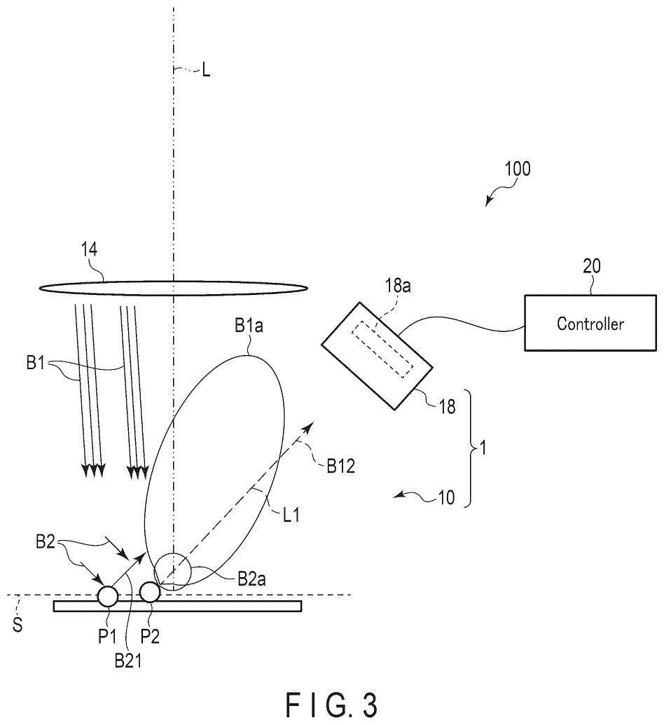

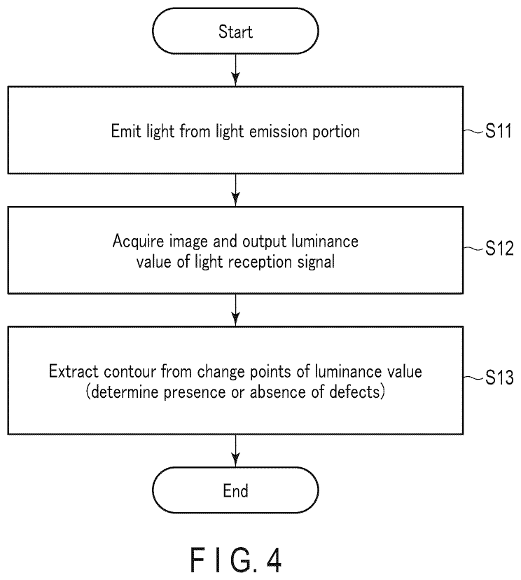

FIG. 3 is a diagram in which the observer V illustrated in FIG. 2 is changed to an imaging unit 18. An optical inspection apparatus 1 includes the optical apparatus 10 and the imaging unit 18 that captures an image illuminated by the optical apparatus 10. A controller 20 is connected to an image sensor 18a of the imaging unit 18 to form an optical inspection system 100 that includes the controller 20 and the optical inspection apparatus 1. FIG. 4 illustrates a processing flow of an optical inspection using the controller 20.

As illustrated in FIG. 3, the optical apparatus 10 can perform observation using the imaging unit 18 including the image sensor 18a, instead of observation by the observer V. That is, the optical axis direction of the imaging unit 18 is along the direction in which the second light beam B2 is specularly reflected by the smooth surface. The controller 20 is connected to the image sensor 18a of the imaging unit 18 in a wired or wireless manner.

The controller 20 is a computer that controls the light emission portion 12 and the image sensor 18a of the imaging unit 18, for example. The controller 20 includes a processor, a ROM (storage unit), a RAM, an auxiliary storage device (storage unit), a communication interface (communication unit), and the like.

The processor is equivalent to a central part of a computer that performs processing such as calculation and control necessary for processing by the controller 20, and comprehensively controls the entire controller 20. The processor performs control to implement various functions of the controller 20, based on programs such as system software, application software, or firmware stored in a storage unit such as a ROM or an auxiliary storage apparatus. The processor includes a central processing unit (CPU), a micro processing unit (MPU), a digital signal processor (DSP), an application specific integrated circuit (ASIC), a field programmable gate array (FPGA), or the like, for example. Alternatively, the processor is a combination of two or more of these. One or more processors may be provided in the controller 20.

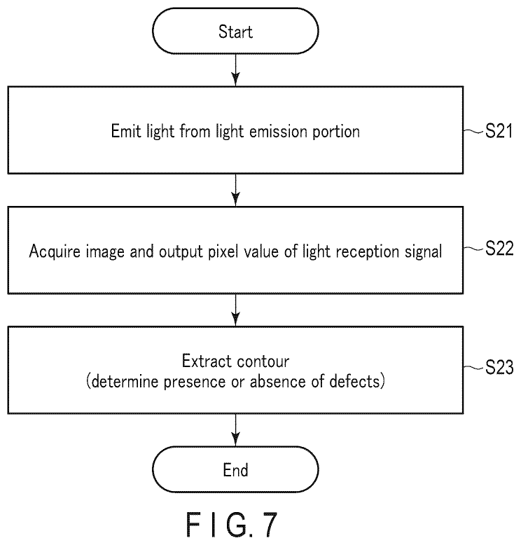

The ROM is equivalent to a main storage apparatus of a computer mainly including a processor. The ROM is a nonvolatile memory exclusively used for reading data. The ROM stores an optical inspection program based on the flow shown in FIGS. 4, 7, and the like, for example. The ROM also stores data, various setting values, or the like used by the processor to perform various processes.

The RAM is equivalent to a main storage apparatus of a computer mainly including a processor. The RAM is a memory used for reading and writing data. The RAM is used as a work area or the like in which data temporarily used by the processor to perform various processes is stored.

The auxiliary storage apparatus is equivalent to an auxiliary storage unit of a computer mainly including a processor. The auxiliary storage apparatus is an electrically erasable programmable read-only memory (EEPROM) (registered trademark), a hard disk drive (HDD), or a solid state drive (SSD), for example. The auxiliary storage apparatus may store an optical inspection program based on the flow shown in FIGS. 4, 7, and the like. The auxiliary storage apparatus can also store data used by the processor to perform various types of processing, data generated by processing in the processor, various setting values, and the like.

The programs stored in the ROM or the auxiliary storage apparatus includes a program for controlling the controller 20. For example, the optical inspection program based on the flow shown in FIGS. 4, 7, and the like is preferably stored in the ROM or the auxiliary storage apparatus.

The communication interface is an interface for communicating with another apparatus via a network or the like in a wired or wireless manner, receiving various types of information transmitted from the other apparatus, and transmitting various types of information to the other apparatus. The optical inspection program of the optical inspection system 100 may be executed on a server or a cloud of various systems separated from the optical inspection apparatus 1 via the communication interface of the controller 20. Therefore, it is also preferable that the optical inspection program is not stored in the ROM or the auxiliary storage apparatus, but is provided on a server or a cloud, and the optical inspection program is executed while communicating with the controller 20 included in the optical inspection system 100 via the communication interface, for example.

The image sensor 18a includes at least two different color channels, and can separate RGB and detect a luminance value (pixel value), for example. The imaging unit 18 has an imaging optical element (not illustrated) that forms an image on the image sensor 18a.

As described above, the reflected light from the first object point P1 will be discussed. The first light beam B1 is specularly reflected at the first object point P1, and reflected along the optical axis L. Therefore, the reflected light does not return to the imaging unit 18 and is not observed. On the other hand, the second light beam B2 is also specularly reflected at the first object point P1, and reflected in a direction oblique to the optical axis L. Since the optical axis direction of the imaging unit 18 is set along the specular reflection direction, the reflected light B21 is acquired by the image sensor 18a. That is, the first object point P1 on the smooth surface can be obtained by using the specular reflection light B21 from the second light beam B2 as an image.

Next, the reflected light from the second object point P2 in the presence of minute defects will be discussed. As described above, the luminance of the second scattered light B2a caused by scattering the second light beam B2 becomes low. Therefore, if the imaging unit 18 observes only the second scattered light B2a, the second object point P2 is acquired as a dark image. On the other hand, the imaging unit 18 simultaneously acquires not only the second scattered light B2a caused by scattering the second light beam B2 at the second object point P2 but also the first scattered light B1a caused by scattering the first light beam B1 at second object point P2. That is, the imaging unit 18 acquires the resultant component B12 of the first scattered light B1a and the second scattered light B2a. Since the luminance of the first light beam B1 is higher than the luminance of the second light beam B2, the luminance of the first scattered light beam B1a is accordingly higher than the luminance of the second scattered light beam B2a. Therefore, the scattered light (first scattered light B1a) higher in intensity than the second scattered light B2a reaches the image sensor 18a of the imaging unit 18. That is, in the image obtained by the image sensor 18a, the minute defects at the second object point P2 can be clearly observed.

On the other hand, if the luminance of the first light beam B1 is equal to or lower than the luminance of the second light beam B2, the intensity of the scattered light from the second object point decreases, and the image sensor 18a acquires the second object point P2 as a dark image. Therefore, it is difficult to clearly identify the second object point P2. That is, the optical apparatus 10 according to the present embodiment has an advantageous effect of making the second object point P2 bright and clear.

As described above, if the object surface S is a smooth surface, there is an advantageous effect that the object points P1 and P2 can be acquired as images by the second light beam B2 using the image sensor 18a. Further, if there are minute defects on the object surface S, the imaging unit 18 simultaneously acquires not only the second scattered light B2a caused by the second light beam B2 but also the first scattered light B1a caused by the first light beam B1. The first light beam B1 is higher in luminance than the second light beam B2. Therefore, there is an advantageous effect that the minute defects can be made bright and clear by the scattered light B1a caused by the first light beam B1. As a result, when the imaging unit 18 of the optical apparatus 10 is used, both the smooth surface and the minute defects become bright, and can be clearly observed.

Therefore, as illustrated in FIG. 4, the optical apparatus 10 according to the present embodiment emits light from the light emission portion 12 (step S11) to illuminate the object surface S. The optical apparatus 10 acquires an image of reflected light from the object surface S by the image sensor 18a of the imaging unit 18, and outputs a luminance value (pixel value) of a light reception signal (step S12). The optical apparatus 10 extracts defects at the second object point P2 from the degree of change in luminance value between adjacent pixels of the acquired image (step S13). Therefore, the presence or absence of defects on the object surface S can be determined by using the optical inspection system 100 according to the present embodiment.

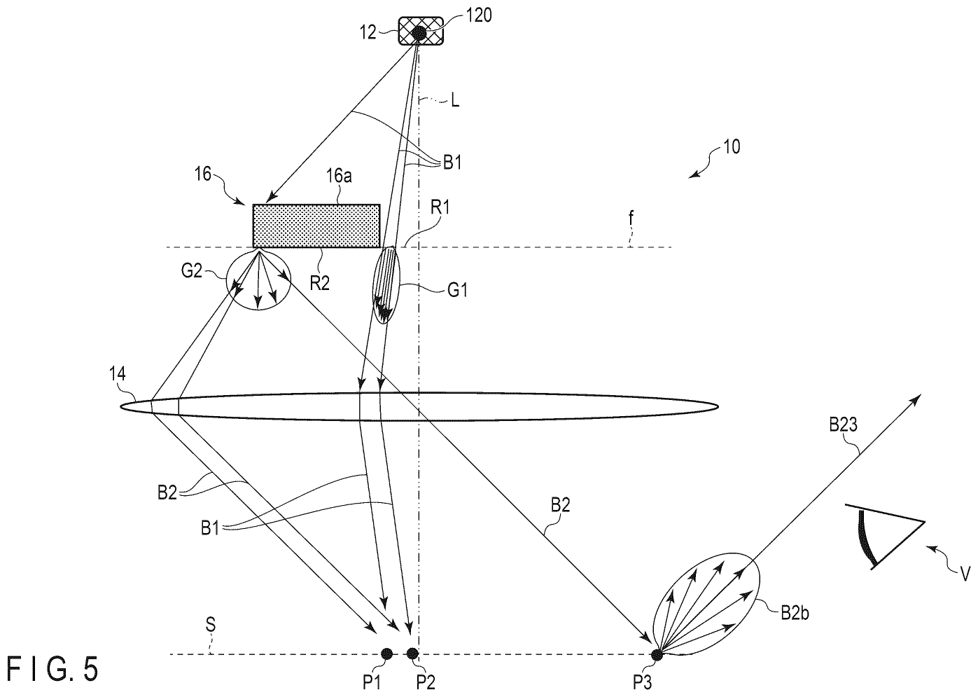

As illustrated in FIG. 5, a case where the irradiation field F is observed from a direction oblique to the optical axis L will be discussed. The object surface S is a flat surface. In the irradiation field F, there is a third object point P3 (see FIG. 1) illuminated only with the second light beam B2. The line-of-sight direction of the observer V is different from the direction of a light beam B23 in which second light beam B2 is specularly reflected at third object point P3 when object surface S is a smooth surface.

The second light beam B2 that is the light from the second light direction selection region R2 can reach the third object point P3 only after the direction of the first light beam B1 is changed by the light direction changer 16a. In the present embodiment, the light direction changer 16a is a diffuser, but the light direction changer 16a does not necessarily need to be a diffuser, and may be anything such as a micro-lens array that changes the direction of light.

On the other hand, if the light direction changer 16a is not provided, the light from the second light direction selection region R2 cannot reach the third object point P3. That is, the light direction changer 16a of the present embodiment has an advantageous effect that the irradiation field F of the second light beam B2 can be set in a wide range.

It is assumed that the third object point P3 is on the smooth surface. At this time, the second light beam B2 is specularly reflected at the third object point P3 and reflected in a direction oblique to the optical axis L. The line-of-sight direction of the observer V is different from the direction of the specularly reflected light beam B23. Accordingly, the light beam B23 in the specular reflection direction is not observed. That is, if the third object point P3 is on the smooth surface, the third object point P3 is not observed.

On the other hand, it is assumed that the third object point P3 is on minute defects. At this time, the second light beam B2 is scattered by the minute defects and diffused (reflected) in various directions. At this time, the observer V observes scattered light B2b caused by the second light beam B2. As described above, if the third object point P3 is on the smooth surface, the third object point P3 is not observed. That is, the third object point P3 is not observed by the illumination light. However, if there are minute defects on the object surface S, the observer V can observe the third object point P3 by the scattered light B2b caused by scattering (reflecting) the second light beam B2. Accordingly, if the third object point P3 is on the minute defects, it is possible to observe a large change in the intensity of light, as compared with the case where the third object point P3 is on the smooth surface. That is, the presence or absence of minute defects can be detected by a change in the intensity of light. Therefore, using the present embodiment has an advantageous effect that the presence or absence of minute defects in a wide field of view including the third object point P3 can be more reliably detected using light intensity information.

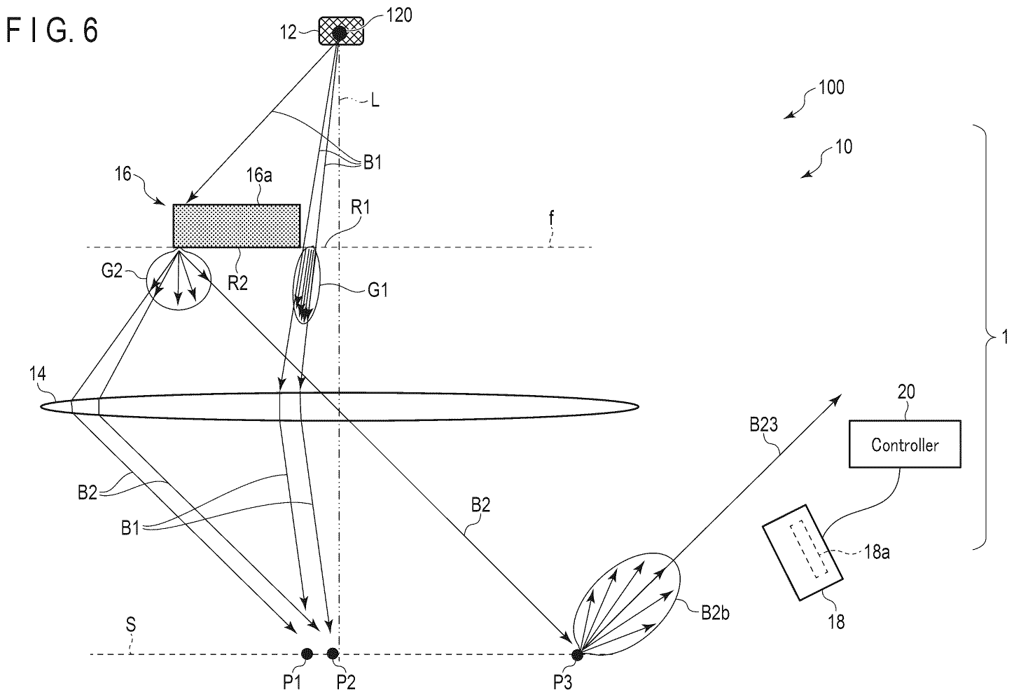

FIG. 6 is a diagram in which observer V illustrated in FIG. 5 is changed to imaging unit 18 (see FIG. 3). The optical inspection apparatus 1 includes the optical apparatus 10 and the imaging unit 18. A controller 20 is connected to an image sensor 18a of the imaging unit 18 to form an optical inspection system 100 that includes the controller 20 and the optical inspection apparatus 1. FIG. 7 illustrates a processing flow of an optical inspection using the controller 20.

It is assumed that the third object point P3 is on the smooth surface. At this time, the second light beam B2 is specularly reflected at the third object point P3 and reflected in a direction oblique to the optical axis L. The optical axis direction of the imaging unit 18 is different from the direction of the specularly reflected light beam B23. Accordingly, an image of light in the specular reflection direction cannot be obtained. That is, if the third object point P3 is on the smooth surface, the image is not acquired by the imaging unit 18.

On the other hand, it is assumed that the third object point P3 is on minute defects. At this time, the second light beam B2 is scattered by the minute defects and diffused (reflected) in various directions. If there are minute defects on the object surface S, the image sensor 18a of the imaging unit 18 can acquire an image of the scattered light B2b caused by scattering (reflecting) the second light beam B2 at the third object point P3. Accordingly, if the third object point P3 is on the minute defects, the image sensor 18a can acquire a large change in the intensity of light as an image, as compared with the case where the third object point P3 is on the smooth surface. That is, the image sensor 18a can detect the presence or absence of minute defects by a change in the intensity of light. Therefore, using the present embodiment has an advantageous effect that the presence or absence of minute defects in a wide field of view including the third object point P3 can be more reliably detected using light intensity information.

Therefore, as illustrated in FIG. 7, the optical apparatus 10 according to the present embodiment emits light from the light emission portion 12 (step S21) to illuminate the object surface S. The optical apparatus 10 acquires an image of reflected light from the object surface S by the image sensor 18a of the imaging unit 18, and outputs a luminance value (pixel value) of a light reception signal (step S22). The optical apparatus 10 extracts defects at the third object point P3 from the degree of change in luminance value between adjacent pixels of the acquired image (step S23). Therefore, the presence or absence of defects on the object surface S can be determined by using the optical inspection system 100 according to the present embodiment.

The first light beam B1 incident on the first light direction selection region R1 or the second light direction selection region R2 is emitted from the light direction changer 16a according to the present embodiment, as a light beam having different optical characteristics according to these regions. That is, the light beam is emitted as the first light beam B1 or as the second light beam B2 having optical characteristics different from those of the first light beam B1. Then, in one of the light direction selection regions R1 and R2, the direction of the incident light beam B1 is changed to a different direction, and the light beam B2 is emitted. Therefore, according to the present embodiment, there are provided the optical apparatus 10, the optical inspection apparatus 1 including the optical apparatus 10, and the optical inspection system 100 including the optical inspection apparatus 1, capable of illuminating the object O with the light beam B2 of which the direction is changed from the direction of at least some of the light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2.

An optical inspection method includes emitting the first light beam B1 of the first wavelength spectrum including the first wavelength toward the image-forming optical element 14, and changing the first light beam B1 incident on the first light direction selection region R1 or the second light direction selection region R2 of the light direction selection portion 16 provided in the focal plane f or the focal plane region Rf near the focal plane f of the image-forming optical element 14 to the light beam B2 having different optical characteristics according to the regions, and emitting the light beam B2 in a direction different from the incident direction of the first light beam B1 to illuminate the object O. According to the present embodiment, there is provided an optical inspection method by which the object O can be illuminated with the light beams B2 of which the direction is changed from the direction of at least some of the light beams B1 emitted from the light emission portion 12.

The optical inspection method also includes acquiring information on the surface S of the object O by light from the illuminated object O. At least some of the light beams B1 emitted from the light emission portion 12 can be emitted as the light beams B2 having optical characteristics different from those of the light beams B1 according to the first light direction selection region R1 or the second light direction selection region R2.

The light direction selection portion 16 includes the diffuser 16a that is arranged in at least one of the first light direction selection region R1 or the second light direction selection region R2, generates at least two light beams B1 and B2 in a direction (direction of the light beam B2) different from the direction of the incident light (light beam B1), and diffuses the light. Therefore, the wide irradiation field F can be simultaneously illuminated with the light beams B1 and B2.

### (Modification 1)

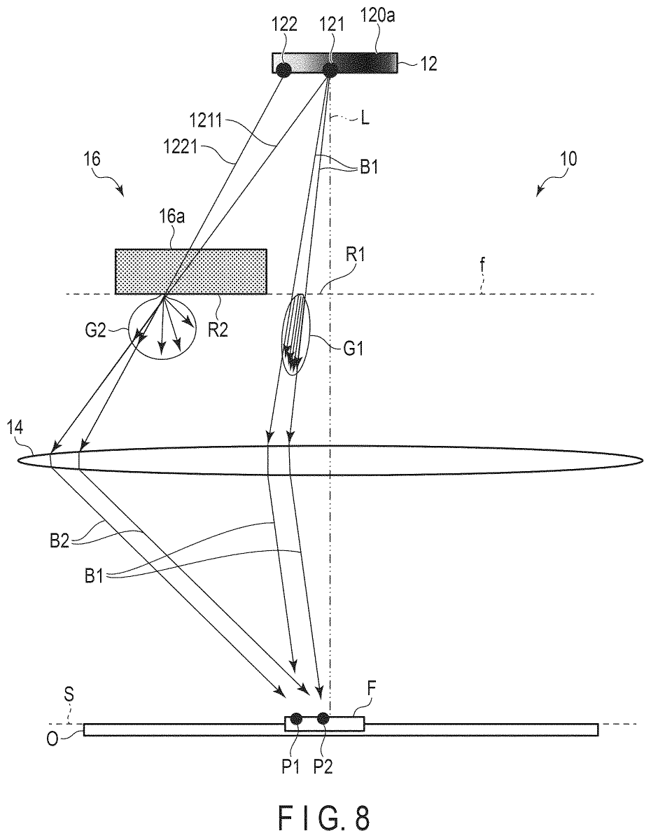

FIG. 8 illustrates a cross-sectional view of a modification of the optical apparatus 10. The cross-sectional view includes an optical axis L. In the first embodiment, the light source of the light emission portion 12 is the point light source 120, but the light source in the present modification is a surface light source 120a. The surface light source 120a is an LED, for example. The LED 120a emits a first light beam B1 of a first wavelength spectrum. In general, the light emission surface of an LED is not uniform but has illuminance unevenness. That is, there is distribution unevenness in the brightness of the light emission surface.

Two different points on the light emission surface of the surface light source 120a are set as a first light source point 121 and a second light source point 122. From these light source points 121 and 122, the first light beam B1 of the first wavelength spectrum is emitted. However, the light beams from the first light source point 121 and the second light source point 122 are different in luminance due to the distribution unevenness of brightness of the light emission surface.

A case where a light diffuser 16a is not present in a second light direction selection region R2 will be discussed. At this time, first virtual straight light 1211 and second virtual straight light 1221 are emitted from the first light source point 121 and the second light source point 122, respectively, and travel straight through the second light direction selection region R2. Here, both the first virtual straight light 1211 and the second virtual straight light 1221 are different in luminance due to the illuminance unevenness of the light emission surface. These light beams (the first virtual straight light 1211 and the second virtual straight light 1221) form a second light direction group G2 at a point in the second light direction selection region R2. The light beams belonging to the second light direction group G2 will be defined as second light beams B2. Further, the light beams reach the first object point P1 and the second object point P2 by an image-forming optical element 14, respectively. At the first object point P1 and the second object point P2, the second light beams B2 identical in incident angle but different in luminance are incident. Accordingly, in an attempt to detect the presence or absence of minute defects at the first object point P1 and the second object point P2, the second light beams B2, which are incident light beams, are different in luminance from each other. Therefore, even if the first object point P1 and the second object point P2 are on the smooth surface, for example, the intensities of the reflected light are different from each other. Similarly, even if the first object point P1 and the second object point P2 are on the minute defects, the intensities of the reflected light are different from each other. That is, it is difficult to determine the presence or absence of minute defects at both the object points P1 and P2 using the light intensity information.

On the other hand, in the present modification, the light diffuser 16a is provided in the second light direction selection region R2. Accordingly, in the second light direction group G2 formed at the point in the second light direction selection region R2, the luminance of the light beams B2 in their respective directions are made uniform. This is a general feature of the light diffuser 16a, and it is known that the luminance is made uniform as the degree to which the light diffuser 16a diffuses light increases. That is, the direction distribution of the light intensity approaches Lambertian. Accordingly, even if the points 121 and 122 of the light emission surface are different in luminance, the luminance of the second light direction group G2 can be made uniform. Therefore, there is an advantageous effect that the second light beam B2 incident on the first object point P1 and the second object point P2 can be made equal to each other in the magnitude of luminance. Such an advantageous effect can be obtained only by changing the direction of the incident light using the light diffuser 16a or the like. That is, the luminance of the two light beams of the second light direction group G2 can be adjusted only when the light diffuser 16a is the light direction changer. Accordingly, in detecting the presence or absence of the minute defect at the first object point P1 and the second object point P2, since the second light beams B2, which are incident light beams, are substantially equal in luminance, there is an advantageous effect that the presence or absence of minute defects can be determined using the information of light intensity, that is, using the relationship between the magnitudes of light intensities at both the object points P1 and P2.

### (Modification 2)

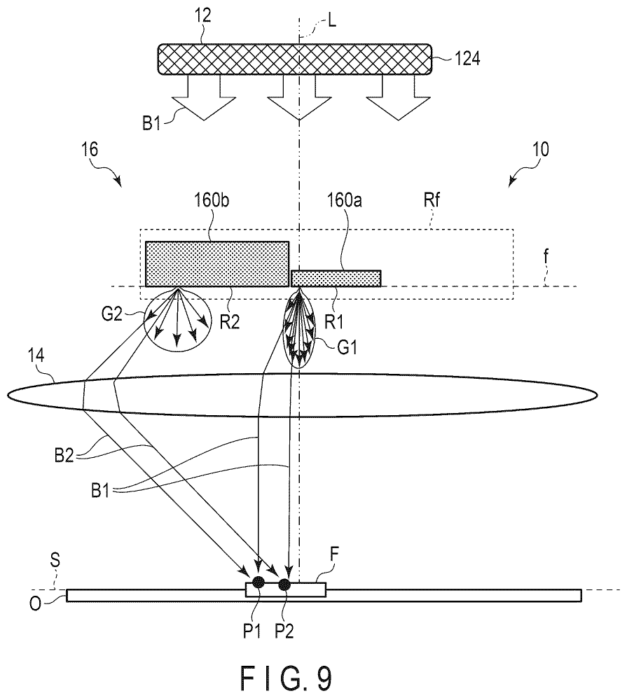

FIG. 9 illustrates a cross-sectional view of Modification 2 of the optical apparatus 10. The cross-sectional view includes an optical axis L. In the first embodiment, the light source of the light emission portion 12 is the point light source 120, but the light source in the present modification is a laser light source 124. The laser light source 124 emits light with high straightness close to parallel light. The laser light source 124 also emits light with a narrow wavelength spectrum width. The peak wavelength of the wavelength spectrum will be defined as a first wavelength.

In a first light direction selection region R1 and a second light direction selection region R2 of a light direction selection portion 16, a first light diffuser 160a and a second light diffuser 160b are arranged, respectively.

The laser light source 124 irradiates at least the first light diffuser 160a and the second light diffuser 160b with a light beam B1 with a wavelength spectrum whose peak wavelength is the first wavelength.

These light diffusers 160a and 160b can diffuse light, but the degrees of diffusing light are different from each other. That is, when the first light beam B1 is incident on each of the light diffusers 160a and 160b, the light beams of a first light direction group G1 and a second light direction group G2 are different in luminance. That is, one of the light diffusers 160a and 160b is arranged here as a light attenuator that is configured to attenuate the light of the first wavelength. In a case where both the light diffusers 160a and 160b are light attenuators, the attenuation degrees of the light diffusers are different from each other.

The end surfaces of the light diffusers 160a and 160b as the light attenuators may be tapered as appropriate along the optical axis L. In this case, the cross sections of the light diffusers 160a and 160b illustrated in FIG. 9 have a trapezoidal shape as an example, and the length between the upper base (positions indicated by lead lines with numerical signs 160a and 160b) and the lower base (positions on the focal plane f) may be longer in either one of the light diffusers 160a and 160b. There is an advantageous effect that the amount of light reflected by the end surfaces of the light diffusers 160a and 160b as the light attenuators can be adjusted by the taper to adjust the intensity distribution of the first light direction group G1 or the second light direction group G2.

As illustrated in FIG. 2 or 3 of the first embodiment described above, a case where the irradiation field F is observed from a direction oblique to the optical axis L will be discussed. The object surface S is a flat surface. In the irradiation field F, the first object point P1 of the object surface S is present on a smooth surface. On the other hand, there are minute defect at a second object point P2, and the minute defects scatter light. The line-of-sight direction of an observer V is along the direction in which the second light beam B2 is specularly reflected by the smooth surface.

The second light beam B2 is generated by diffusing the first light beam B1 by the diffuser 160b. That is, the second light beam B2 is generated by branching the first light beam B1. Therefore, the luminance of the second light beam B2 is smaller than that of the first light beam B1.

First, reflected light from the first object point P1 will be discussed. The first light beam B1 is specularly reflected at the first object point P1, and reflected along the optical axis L. Therefore, the reflected light does not return to the observer V and is not observed. On the other hand, the second light beam B2 is also specularly reflected at the first object point P1, and reflected in a direction oblique to the optical axis L. Since the line-of-sight direction of the observer V is set along the specular reflection direction (see FIG. 2), reflected light B21 (see FIG. 2) is observed. That is, the first object point P1 on the smooth surface can be observed by the specularly reflected light B21 from the second light beam B2.

Next, reflected light from the second object point P2 will be discussed. Since the minute defects exist at the second object point P2, both the first light beam B1 and the second light beam B2 are scattered by the minute defects and diffused (reflected) in various directions. In general, the BRDF of minute defects has a wide distribution around the specular reflection direction. In this case, the observer V simultaneously observes not only first scattered light B1a (see FIG. 2) from the first light beam B1 but also second scattered light B2a (see FIG. 2) from the second light beam B2. That is, the observer V observes a resultant component B12 of the first scattered light B1a and the second scattered light B2a. There is an advantageous effect that the ratio in magnitude of the luminance of the first light beam B1 and the luminance of the second light beam B2 can be adjusted by changing the types of the first light diffuser 160a and the second light diffuser 160b. Therefore, the brightness of the minute defects can be adjusted by adjusting the degree of diffusion of the first light diffuser 160a, for example. By making such adjustment, it is possible to increase a difference in intensity of reflected light (or scattered light), that is, a difference in brightness between the first object point P1 on the smooth surface and the second object point P2 on the minute defects. Therefore, both object points can be identified by a difference in light intensity, that is, a difference in brightness.

As described above, if the object surface S is a smooth surface, there is an advantageous effect that the object points P1 and P2 can be observed by the second light beam B2. On the other hand, if there are minute defects on the object surface S, the observer V simultaneously observes not only the second scattered light B2a caused by the second light beam B2 but also the first scattered light B1a caused by the first light beam B1. The ratio in magnitude of the luminance of the first light beam B1 and the luminance of the second light beam B2 can be adjusted by the first light diffuser 160a and the second light diffuser 160b. Therefore, the brightness of the minute defects can be adjusted by adjusting the degree of diffusion of the first light diffuser 160a, for example. This makes it possible to observe an appropriate light intensity change between when there are minute defects on the smooth surface and when there are no minute defects on the smooth surface. That is, the use of the optical apparatus 10 according to the present modification has an advantageous effect that the presence or absence of minute defects can be more reliably detected using light intensity information.

### (Modification 3)

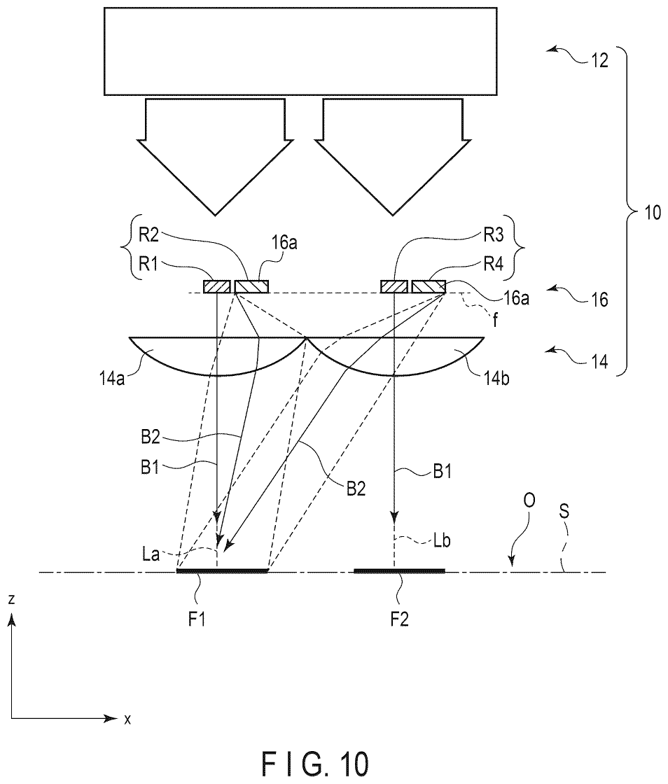

FIG. 10 illustrates a cross-sectional view of Modification 3 of the optical apparatus (illumination portion) 10.

In the present modification, an image-forming optical element 14 of the illumination portion 10 is an image-forming optical element array. The image-forming optical element array 14 includes at least two image-forming optical elements 14a and 14b, and these image-forming optical elements 14a and 14b are adjacent along an x-axis direction. In the image-forming optical element array 14, a plurality of image-forming optical elements 14a, 14b, . . . is preferably arranged in an array.

A light direction selection portion 16 includes a first light direction selection region R1, a second light direction selection region R2, a third light direction selection region R3, and a fourth light direction selection region R4. The first light direction selection region R1 and the second light direction selection region R2 face the first image-forming optical element 14a. The third light direction selection region R3 and the fourth light direction selection region R4 face the second image-forming optical element 14b.

The first light direction selection region R1 is provided on an optical axis La of the first image-forming optical element 14a. The second light direction selection region R2 is adjacent to the first light direction selection region R1. The third light direction selection region R3 is provided on an optical axis Lb of the second image-forming optical element 14b. The fourth light direction selection region R4 is adjacent to the third light direction selection region R3. The configurations of the first light direction selection region R1 and the second light direction selection region R2 with respect to the first image-forming optical element 14a and the configurations of the third light direction selection region R3 and the fourth light direction selection region R4 with respect to the second image-forming optical element 14b are preferably the same.

The image-forming optical elements 14a and 14b of the image-forming optical element array 14 have a function of collecting a light beam group emitted from a certain point to a conjugate image point. In the present modification, the image-forming optical element array 14 is a lens array, and the two image-forming optical elements 14a and 14b forming the lens array 14 are Fresnel lenses, for example.

The optical axes La and Lb of the lens elements 14a and 14b are included in the cross section of FIG. 10, and they are parallel to a z axis. The optical axis La of the first lens element 14a and the optical axis Lb of the second lens element 14b will be defined as first optical axis La and second optical axis Lb, respectively.

The first light direction selection region R1 and the second light direction selection region R2 are formed on or near a focal plane f of the first lens element 14a. The third light direction selection region R3 and the fourth light direction selection region R4 are formed on or near a focal plane f of the second lens element 14b. In the present modification, the focal planes f of the first lens element 14a and the second lens element 14b are on the same plane.

As described in relation to the first embodiment, a first light beam B1, which has reached the first light direction selection region R1 and the third light direction selection region R3 from a light emission portion 12, passes as the original light beam B1. The first light beam B1, which has reached the second light direction selection region R2 and the fourth light direction selection region R4 from the light emission portion 12, newly generates a second light beam B2 different in direction from the first light beam B1.

The operations of the above optical apparatus 10 according to the present embodiment will be described.

In the present modification, an object O reflects light. At this time, an object surface S of the object O is illuminated by the light from the light emission portion 12 of the illumination portion 10. The illuminated regions on the object surface S will be referred to as irradiation fields F1 and F2. However, the object is not limited to this, and the object O may be transparent or semi-translucent to light.

The light having passed through the first light direction selection region R1 is propagated in parallel along the first optical axis La by the first lens element 14a and reaches the irradiation field F1. On the other hand, the light having passed through the second light direction selection region R2 is propagated in a direction inclined to the first optical axis La by the first lens element 14a and reaches the irradiation field F1.

The light having passed through the third light direction selection region R3 is propagated in parallel along the second optical axis Lb by the second lens element 14b, reaches the object surface S, and illuminates the object surface S. The illuminated region will be referred to as irradiation field F2. On the other hand, the light having passed through the fourth light direction selection region R4 is propagated in a direction inclined to the second optical axis Lb by the second lens element 14b, and reaches the irradiation field F1 formed by the light having passed through the first light direction selection region R1 and the second light direction selection region R2.

Therefore, the irradiation field F1 is irradiated with at least the first light beam B1 having passed through the first light direction selection region R1, the second light beam B2 having passed through the second light direction selection region R2, and the second light beam B2 having passed through the fourth light direction selection region R4 in an overlapping state. That is, a region is formed in which the light beams B1 and B2 from different directions overlap simultaneously. Therefore, the optical apparatus 10 according to the present modification irradiates the same irradiation field F1 of the object O with the light beams B1 and B2 from a plurality of directions. Since the second light beam B2 having passed through the second light direction selection region R2 and the second light beam B2 having passed through the fourth light direction selection region R4 are radiated in an overlapping state, there is an advantageous effect that the illuminance unevenness of the irradiation field F1 is smoothed, as compared with the case of using only one of the light beams. This is because the illuminance unevenness is reduced as light beams having various kinds of illuminance unevenness are overlapped.

A case where the irradiation field F1 is observed by an observer from an oblique direction (line-of-sight direction) with respect to the first optical axis L1 will be discussed. It is assumed that the object surface S is a flat surface.

If the object surface S in the irradiation field F1 is a smooth surface, the light beam B1 having passed through the first light direction selection region R1 is specularly reflected and reflected along the first optical axis L1. Therefore, the reflected light does not return to the observer, and the observer does not observe the light with a wavelength spectrum a.

The light beam B2 having passed through the second light direction selection region R2 is specularly reflected in the irradiation field F1 and reflected in a direction oblique to the first optical axis La. At this time, there is a possibility that the reflected light generated by the light beam B2 returns to the observer who observes in a direction oblique to the optical axis La (line-of-sight direction). The light beam B2 having passed through the fourth light direction selection region R4 is also specularly reflected in the irradiation field F1 and reflected in a direction oblique to the first optical axis La. At this time, there is a possibility that the reflected light generated by the light beam B2 having passed through the fourth light direction selection region R4 returns to the observer who observes in a direction oblique to the optical axis La. Accordingly, the light beam B2 may be observed by the observer, but the light beam B1 is not observed. That is, the observer can observe the light beam B2 if the object surface is a smooth surface.

On the other hand, if there are minute defects (minute asperities) on the object surface S in the irradiation field F1, not only the light beam B2 but also the light beam B1 are observed at the same time because the light is scattered by the minute defects to spread the angular distribution. This has an advantageous effect that defects are observed brightly. In the present embodiment, the illuminance unevenness of the smooth surface in the irradiation field F1 is reduced. Therefore, for the observer, the change of light intensity due to the minute defects has a larger intensity contrast than the intensity contrast of the smooth surface region caused by the illuminance unevenness. That is, there is an advantageous effect that minute defects can be more clearly identified.

### Second Embodiment

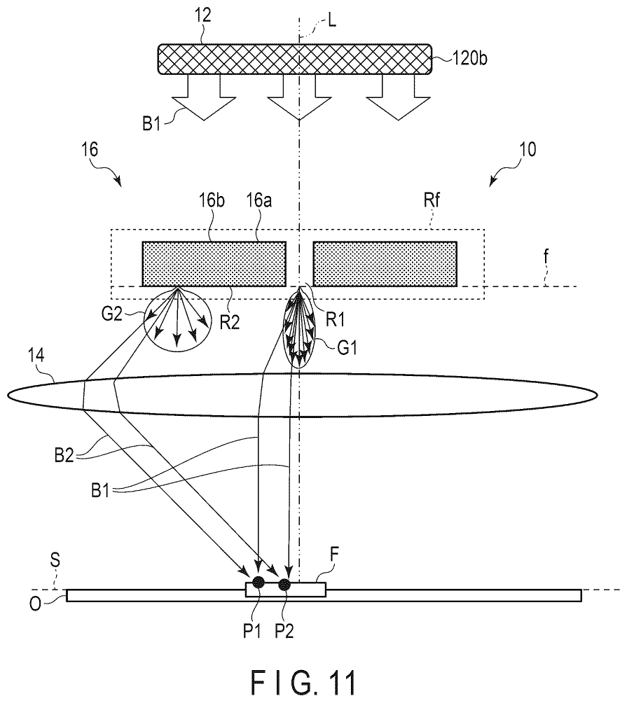

Hereinafter, an optical inspection apparatus according to the present embodiment will be described with reference to FIG. 11.

FIG. 11 is a schematic cross-sectional view of an optical apparatus 10 according to the present embodiment. The optical apparatus 10 according to the present embodiment includes a light emission portion 12, an image-forming optical element 14, and a light direction selection portion 16.

The light emission portion 12 includes a light source 120b. The light source 120b emits a first light beam B1 of a first wavelength spectrum including at least a first wavelength. For example, the first wavelength is 405 nm, and the first wavelength spectrum has a peak at the first wavelength. Light having such a first wavelength spectrum will be referred to as blue light. However, the wavelength spectrum of the light source 120b is not limited to this, and the wavelength spectrum of the light source 120b may be any wavelength spectrum. For example, the light of the light source may be white light.

The light source 120b is a surface-emitting light-emitting diode (LED) that emits blue light. However, the light source 120b is not limited to this, and any light source may be used as long as it emits light. The light source may be a laser diode (LD). Alternatively, the light source 120b may be sunlight, a plasma light source, a thermal radiation light source (incandescent lamp, halogen lamp, xenon lamp, and the like), or the like.

The image-forming optical element 14 can form an image of light. The image-forming optical element 14 may be a single lens, a set lens including a plurality of lenses, a concave mirror, a Fresnel lens, a diffraction grating, a gradient index lens (GRIN lens), or the like, for example. That is, the image-forming optical element 14 may be any element as long as it can form an image of light. A plane on which a set of points at infinity is imaged by the image-forming optical element 14 will be defined as a focal plane f. The focal plane f and its vicinity will be referred to as a focal plane region Rf. An optical axis L of the image-forming optical element 14 is a straight line orthogonal to the focal plane f. Light emitted from a sufficiently distant point on the optical axis L is imaged at a point where the optical axis and the focal plane f intersect. This point will be referred to as a focal point.

The image-forming optical element 14 of the present embodiment is a set lens including a plurality of lenses. This will be referred here to as an image-forming lens. However, FIG. 11 schematically illustrates an image-forming lens which is a set lens, as one lens, for the sake of simplicity. The image-forming optical element is not limited to this, and may be any element as long as it forms an image of light. In the cross-sectional view of FIG. 11, the optical axis L of the image-forming optical element 14 is included in this cross section.

The light direction selection portion 16 includes a first light direction selection region R1 and a second light direction selection region R2 on or near the focal plane f of the image-forming optical element 14. That is, the light direction selection portion 16 has the first light direction selection region R1 and the second light direction selection region R2 in the focal plane region Rf. The first light direction selection region R1 passes the first light beam B1 of the first wavelength included in the first wavelength spectrum while changing the optical characteristics of the first light beam B1 or without changing the optical characteristics of the first light beam B1. In the present embodiment, the first light direction selection region R1 passes the first light beam B1 as it is without changing the optical characteristics. A set of first light beams B1 facing different various directions from a point existing in the first light direction selection region R1 will be defined as a first light direction group G1. The second light direction selection region R2 changes the optical characteristics of the first light beam B1. The optical characteristics here include a direction of a light beam, a wavelength, a wavelength spectrum, polarized light, luminance, illuminance, and a light flux (light amount).

The light direction selection portion 16 includes a light direction changer 16a in the second light direction selection region R2. The light direction changer 16a may be made of anything such as a phosphor, frosted glass, a holographic diffuser, a diffraction grating, a transparent resin in which particles that scatter light are dispersed, silk printing, or paper, for example. The light is diffused to produce at least two beams, including beams traveling in a direction different from the direction of incidence. That is, at least one light beam B2 at least partially different in optical characteristics from the incident light beam B1 is newly generated. The amount of light (total light flux) can be maintained before and after the light is diffused. That is, the light can be diffused without changing the amount of light. However, the amount of light may be changed by diffusion.

In the present embodiment, the light direction changer 16a is a phosphor (wavelength conversion diffuser) 16b. The phosphor 16b is configured to convert the first wavelength into the second wavelength. For example, the second wavelength is 650 nm. The light of the second wavelength spectrum has the second wavelength as the peak wavelength. That is, the light of the second wavelength spectrum is red light. However, the second wavelength is not limited to this, and may be any wavelength as long as it is different from the first wavelength. When once absorbing light and emitting light of a different wavelength, the phosphor 16b emits at least one light beam in a direction different from the incident direction of the light. Therefore, the phosphor 16b is used as a wavelength conversion diffuser that converts the wavelength of incident light and diffuses emitted light.

Next, the operations of the optical apparatus 10 according to the present embodiment will be described.

Referring to FIG. 11, light of the first wavelength spectrum is emitted from the surface emitting LED 120b of the light emission portion 12. The first light beam B1 is light of the first wavelength included in the first wavelength spectrum. The first light beam B1 travels toward the light direction selection portion 16 and reaches the first light direction selection region R1 or the second light direction selection region R2, or both.

The first light beam B1 having reached the first light direction selection region R1 passes as it is. A set of first light beams B1 passing through a point existing in the first light direction selection region R1 will be defined as the first light direction group G1. On the other hand, a second light beam B2 of a direction and a wavelength different from those of the first light beam B1 is newly generated by the phosphor 16b provided in the second light direction selection region R2. A set of second light beams B2 passing through a point existing in the second light direction selection region R2 will be defined as a second light direction group G2. The phosphor 16b makes the second light beam B2 have a second wavelength different from the first wavelength.

The first light direction selection region R1 and the second light direction selection region R2 are positioned on the focal plane f or near the focal plane f of the image-forming optical element 14, and are different from each other in position. Therefore, as illustrated in FIG. 11, the first light beam B1, which is one light beam of the first light direction group G1, and the second light beam B2, which is one light beam of the second light direction group G2, have different inclination angles with respect to the optical axis L when passing through the image-forming optical element 14. That is, based on the geometric optics, the inclination angle with respect to the optical axis L is determined according to the position where the light beam B1 passes through the focal plane f.

An irradiation field F is a region of the object surface S illuminated by the first light beam B1 or the second light beam B2, or both of the light beams B1 and B2. In the present embodiment, there are two different points in the irradiation field F illuminated by both the first light beam B1 and the second light beam B2. These will be referred to as a first object point P1 and a second object point P2.

As illustrated in FIG. 2 of the first embodiment, a case where the irradiation field F is observed by an observer V from a direction oblique to the optical axis L will be discussed. The object surface S is a flat surface. In the irradiation field F, the first object point P1 of the object surface S is present on a smooth surface. On the other hand, minute defects (minute asperities) exist at the second object point P2, and the minute defects scatter light. The line-of-sight direction of an observer V is along the direction in which the second light beam B2 is specularly reflected by the smooth surface. The second light beam B2 is obtained by converting the first light beam B1 into light of a second wavelength by the phosphor.

First, reflected light from the first object point P1 will be discussed. The first light beam B1 is specularly reflected at the first object point P1, and reflected along the optical axis L. Therefore, the reflected light of the first light beam B1 reflected at the first object point P1 does not return to the observer V, and the observer V cannot observe the reflected light. On the other hand, the second light beam B2 is also specularly reflected at the first object point P1, and reflected in a direction oblique to the optical axis L. Since the line-of-sight direction of the observer V is set along the specular reflection direction, reflected light is observed. That is, the first object point P1 on the smooth surface can be observed by the specularly reflected light from the second light beam B2. At this time, the second light beam B2 is light of a second wavelength and is red light. That is, the first object point P1 on the smooth surface is observed by red light.

Next, reflected light from the second object point P2 will be discussed. Since the minute defects exist at the second object point P2, both the first light beam B1 and the second light beam B2 are scattered by the minute defects and diffused (reflected) in various directions. Such a reflection characteristic can be described by a bidirectional reflectance distribution function (BRDF) representing the intensity of light for each reflection direction. The angular distribution of the light described by the BRDF becomes a narrow distribution having a specular reflection component as a main component in the case of a smooth surface, and becomes a wide distribution in the case of minute defects. In general, the BRDF of minute defects has a wide distribution around the specular reflection direction. In this case, the observer simultaneously observes not only first scattered light from the first light beam but also second scattered light from the second light beam. That is, the observer observes a resultant component of the first scattered light and the second scattered light. Therefore, the second object point is observed not only by the light of the first wavelength but also by the light of the second wavelength. That is, the second object point is observed by both blue light and red light.

As described above, a smooth surface on the object surface is observed by red light, and minute defects are observed by blue light and red light. That is, the use of the present embodiment has an advantageous effect that the presence or absence of minute defects can be more reliably detected using light color (hue) information.

The first light beam B1 incident on the first light direction selection region R1 or the second light direction selection region R2 is emitted from the light direction changer 16a according to the present embodiment, as a light beam having different optical characteristics according to these regions. That is, the light beam is emitted as the first light beam B1 or as the second light beam B2 having optical characteristics different from those of the first light beam B1. Then, in one of the regions R1 and R2, the direction of the incident light beam B1 is changed to a different direction, and the light beam B2 is emitted. Therefore, according to the present embodiment, there are provided the optical apparatus 10, the optical inspection apparatus 1 including the optical apparatus 10, and the optical inspection system 100 including the optical inspection apparatus 1, capable of illuminating the object O with the light beams B2 of which the direction is changed from the direction of at least some of the light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2. In addition, according to the present embodiment, there is provided an optical inspection method by which it is possible to illuminate the object O with the light beams B2 of which the direction is changed from the direction of at least some of the light beams B1 emitted from the light emission portion 12, that is, with the light beams B2 different in direction from at least some of the light beams B1. At least some of the light beams B1 emitted from the light emission portion 12 can be emitted as the light beams B2 having optical characteristics different from those of the light beams B1 according to the first light direction selection region R1 or the second light direction selection region R2.

The phosphor 16b of the diffuser 16a is a wavelength conversion diffuser that converts light of a first wavelength into light of a second wavelength different from the first wavelength. The wavelength conversion diffuser 16b is arranged in the second light direction selection region R2. The wavelength conversion diffuser 16b emits light (light beam B2) of the second wavelength spectrum different from the light of the first wavelength spectrum and including the second wavelength from the second light direction selection region R2. Therefore, the optical apparatus 10 according to the present embodiment can emit the light B1 and the light B2 different in direction and optical characteristics other than direction from the light direction selection portion 16 toward the image-forming optical element 14 and the object O.

The use of the present embodiment has an advantageous effect that the presence or absence of minute defects and the BRDF of the minute defects can be detected without using a color filter for the focal plane f.

### (Modification 1)

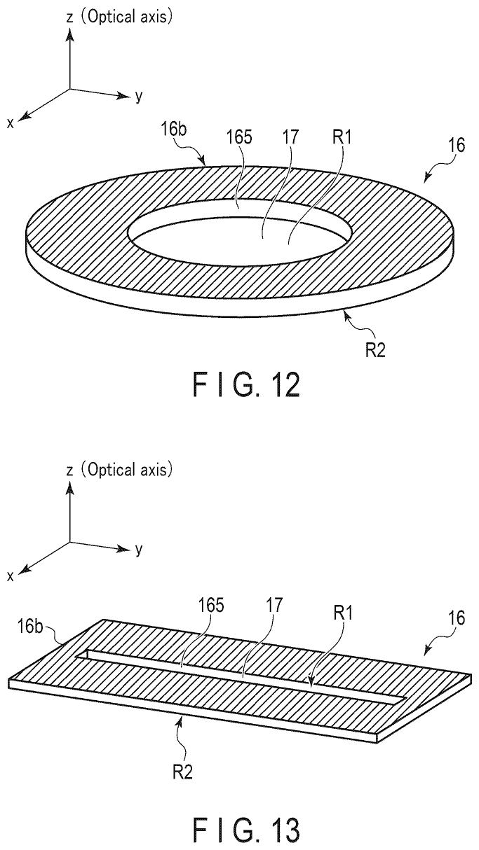

In the present exemplary embodiment, the phosphor 16b of the light direction selection portion 16 may be as illustrated in FIG. 12. In FIG. 12, a z axis will be defined as an optical axis. Further, two axes along directions orthogonal to the z axis will be defined as an x axis and a y axis. A phosphor 16b is formed by providing a through-hole 17 in a thick phosphor plate. The thickness is 0.5 mm to 3 mm, for example. However, the thickness of the phosphor plate 16b is not limited to this, and any configuration may be adopted. The phosphor plate 16b may be made of transparent resin, glass, or the like in which a phosphor is dispersed. A side surface 165 of the through-hole 17 is a glossy surface. However, the side surface 165 of the through-hole 17 is not limited to this, and the side surface 165 of the through-hole 17 may be a diffusion surface.

A region with the through-hole 17 will be defined as a first light direction selection region R1, and a region with the phosphor plate will be defined as a second light direction selection region R2.

Since the side surface 165 of the through-hole 17 is a glossy surface, the light incident on the phosphor plate 16b is totally reflected by the side surface 165, and does not leak from the side surface 165 to the outside. Therefore, the light is confined in the phosphor plate 16b until immediately before being emitted from the second light direction selection region R2, and then is emitted to the outside immediately after reaching the second light direction selective region R2. Accordingly, a first light beam B1 passing through the through-hole 17 and emitted from the first light direction selection region R1 and a light beam B2 emitted from the second light direction selection region R2 are clearly separated from each other without being interlaced with each other. Based on geometric optics, the directions of the light beams B1 and B2 emitted from an image-forming optical element 14 are determined by the positions where the light beams B1 and B2 have passed through a focal plane f. That is, according to the present modification in which the side surface 165 of the phosphor plate 16b arranged on the focal plane f is a glossy surface, the directions of the light beams can be clearly distinguished between the first light beam B1 and the second light beam B2. Since the first light beam B1 and the second light beam B2 have different wavelengths, there is an advantageous effect that the directions of the light beams B1 and B2 can be clearly distinguished by color (hue).

FIG. 12 illustrates an example in which the phosphor plate 16b has a disk-like appearance and the through-hole 17 has a circular shape. As illustrated in FIG. 13, it is also preferable that the appearance of the phosphor plate 16b has the shape of a substantially rectangular plate, and the through-hole 17 is formed in a slit shape. Also in this case, the side surface 165 is formed by the through-hole 17.

### (Modification 2)

In the present embodiment, the phosphor may be as illustrated in FIG. 14. In FIG. 14, a z axis will be defined as an optical axis. Further, two axes along directions orthogonal to the z axis will be defined as an x axis and a y axis. A phosphor 16b may be obtained by boring a through-hole 170 in a thick transparent substrate plate to produce an aperture substrate 167 and forming a coating layer 168 of a phosphor on the aperture substrate 167. The thickness of the aperture substrate 167 is 0.5 mm to 3 mm, for example. However, the thickness of the aperture substrate 167 is not limited to this, and any configuration may be adopted. The coating layer 168 is as thin as about several 100 μm. However, the thickness of the coating layer 168 is not limited to this. According to the present modification, the directions of the light beams can be clearly distinguished between a first light beam B1 and a second light beam B2. Since the first light beam B1 and the second light beam B2 have different wavelengths, there is an advantageous effect that the directions of the light beams B1 and B2 can be clearly distinguished by color (hue).

### (Modification 3)

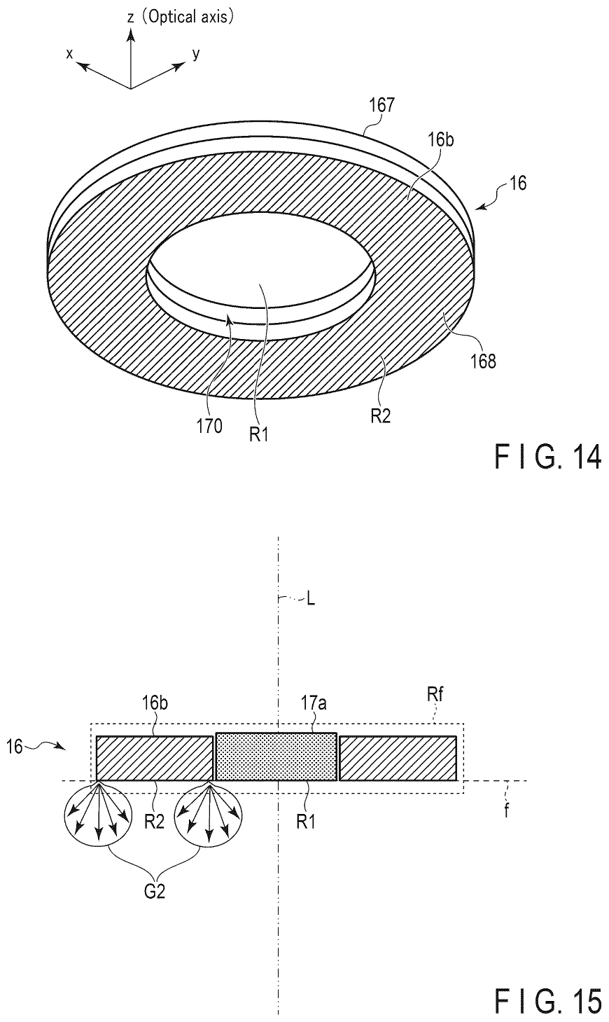

In the present embodiment, the phosphor may be as illustrated in FIG. 15. FIG. 15 illustrates a cross section including an optical axis L. A light blocking body 17a that blocks light is provided in a first light direction selection region R1. That is, a first light beam B1 emitted from a light source 120b (see FIG. 11) does not pass through the first light direction selection region R1. Therefore, a first light direction group G1 is not formed. Alternatively, the light intensity of the first light direction group G1 is zero. Accordingly, the intensity of the first light beam B1 is also zero. As a result, since the first light beam B1 and a second light beam B2 have different wavelengths and intensities, there is an advantageous effect that the directions of the light beams B1 and B2 can be clearly distinguished not only by color (hue) but also by light intensity.

### (Modification 4)

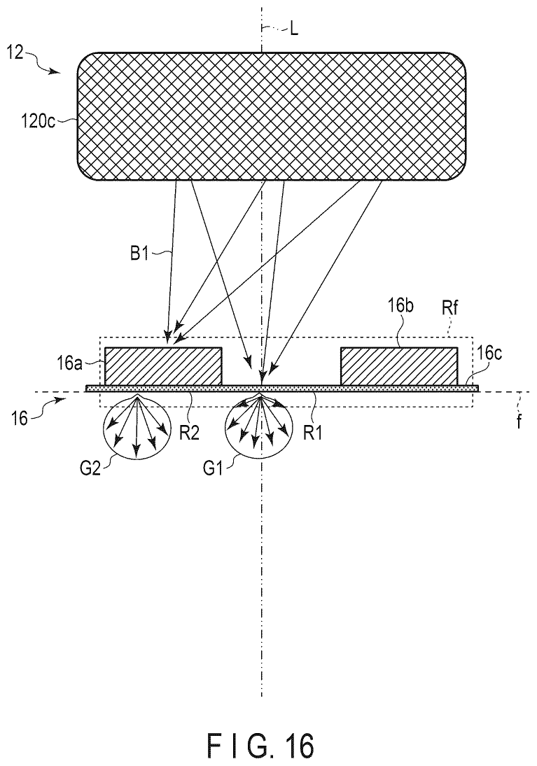

In the present modification, a phosphor 16b may be as illustrated in FIG. 16. FIG. 16 illustrates a cross section including an optical axis L. A diffuser 16c that diffuses light is provided in a first light direction selection region R1. That is, a first light beam B1 emitted from a light source 120c of a light emission portion 12 is diffused in the first light direction selection region R1. Therefore, a first light direction group G1 has a wide angular distribution. The diffuser 16c is also provided in a second light direction selection region R2. A second light direction group G2 similarly has a wide angular distribution by the presence of the light diffuser 16c. This has an advantageous effect that an irradiation field F is widened.

A light emission portion 12 includes a projection portion 120c that can project an image onto the focal plane f or the vicinity of the focal plane. The projection portion 120c is a projector, for example. There is an advantageous effect that the intensity and wavelength of the first light beam B1 and a second light beam B2 can be switched to desired ones by the projector 120c. As the projector 120c, for example, electrically controlled by the controller 20 is used, the light beam B1 is capable of instantaneous switching.

The projector 120c has a liquid crystal display (LCD) system, a digital lighting processing (DLP) system, or a liquid crystal on silicon (LCOS) system. In the LCD projector 120c, light from a light source is separated by a dichroic mirror, the separated light is transmitted through an LCD panel, and then the separated light is multiplexed again. In the DLP projector 120c, light from a light source is turned to light having a wavelength spectrum different for each time using a rotating color wheel, and the light is reflected by a digital micromirror device (DMD). However, in the DLP projector 120c, a plurality of light sources having different wavelength spectra may be prepared in advance so that the light of each wavelength spectrum is reflected by the DMD and then multiplexed without using a color wheel. In the LCOS projector 120c, light from a light source is separated by a dichroic mirror, the separated light is reflected by a reflective liquid crystal panel, and then the separated light is multiplexed again. The projection portion 120c included in the light emission portion 12 according to the present embodiment is a DLP projector.

However, the projector 120c is not limited to these types, and may be any projector that projects light of various wavelengths and intensities toward the focal plane f on which a light direction selection portion 16 is arranged. That is, the projector 120c projects not only the light of a first wavelength spectrum but also light of different wavelength spectra or different intensities.

### Third Embodiment

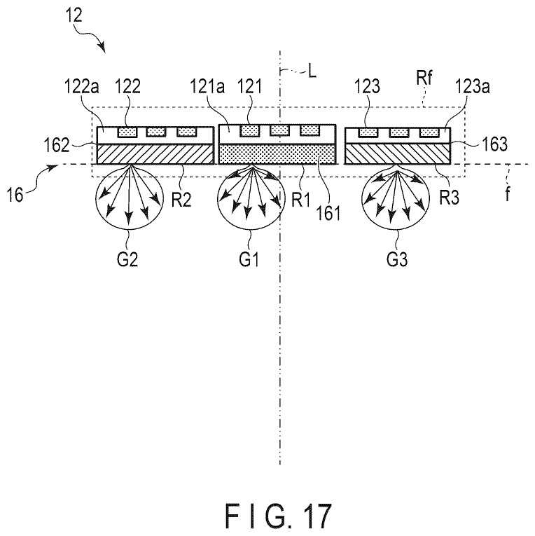

FIG. 17 illustrates a schematic cross-sectional view of a light emission portion 12 and a light direction selection portion 16 of an optical apparatus 10 according to the present embodiment. FIG. 17 does not illustrate an image-forming optical element 14, an object surface S, and the like (see FIG. 11).

The light emission portion 12 includes a first light source 121, a second light source 122, and a third light source 123. The first light source 121, the second light source 122, and the third light source 123 are blue LEDs that emit light of a first wavelength spectrum including a first wavelength. However, these light sources may emit light of different wavelength spectra. That is, any light sources may be used as long as they emit light. The light sources 121, 122, and 123 are sealed by transparent sealing bodies 121a, 122a, and 123a. The sealing bodies 121a, 122a, and 123a may be silicone, for example. However, the sealing bodies 121a, 122a, and 123a are not limited to these, and any material may be used as long as it is a transparent material that transmits light from the light sources 121, 122, and 123.

A diffuser 161 is arranged facing the first light source 121.

A phosphor 162 is arranged so as to face the second light source 122, and a phosphor 163 is arranged so as to face the third light source 123. The phosphor 162 is a quantum dot that converts light of the first wavelength into light of a second wavelength. The light of the second wavelength is red light with a wavelength of 650 nm. The phosphor 163 is a quantum dot that converts light of the first wavelength into light of a third wavelength. The light of the third wavelength is green light with a wavelength of 550 nm.

The light of a second wavelength spectrum includes the second wavelength, and the light of a third wavelength spectrum includes the third wavelength. The first wavelength spectrum, the second wavelength spectrum, and the third wavelength spectrum are different from one another.

A first light direction group G1, a second light direction group G2, and a third light direction group G3 are formed from a first light direction selection region R1, a second light direction selection region R2, and a third light direction selection region R3, respectively.

Next, the operations of the optical apparatus 10 according to the present embodiment will be described.

The divergence angle of light flux immediately after passing through the light direction selection regions R1, R2, and R3 of a focal plane f is larger than that of light flux immediately before. Accordingly, the light flux reaching the image-forming optical element 14 can reach not a local region of the image-forming optical element 14 but a wider region of the same. Therefore, there is an advantageous effect of widening an irradiation field F where the object surface O is irradiated by the image-forming optical element 14.

Further, the use of the present embodiment makes it possible to change the intensities of the first light source 121, the second light source 122, and the third light source 123 independently and instantaneously. That is, light of different wavelengths can be emitted from the first light direction selection region R1, the second light direction selection region R2, and the third light direction selection region R3, and the intensity ratio thereof can be instantaneously adjusted. This has an advantageous effect that the direction of light can be distinguished by wavelength spectrum with respect to the direction of light formed by the image-forming optical element 14, and at the same time, the intensity ratio thereof can be instantaneously switched to a desired one.

From the above, the optical apparatus 10 according to the present embodiment can associate the wavelength spectrum and the light intensity with the direction of a light beam. The wavelength spectrum can be considered synonymous with the color of a light beam. Therefore, it can be said that the direction of a light beam can be associated with the color of the light beam. This has an advantageous effect that the association between the color and the intensity can be instantaneously changed with respect to the direction of a light beam according to various applications.

According to the present embodiment, there are provided the optical apparatus 10, an optical inspection apparatus 1 including the optical apparatus 10, and an optical inspection system 100 including the optical inspection apparatus 1, capable of illuminating an object O with light beams B2 of which the direction is changed from the direction of at least some of light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2. In addition, according to the present embodiment, there is provided an optical inspection method by which the object O can be illuminated with the light beams B2 of which the direction is changed from the direction of at least some of the light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2.

### (Modification)

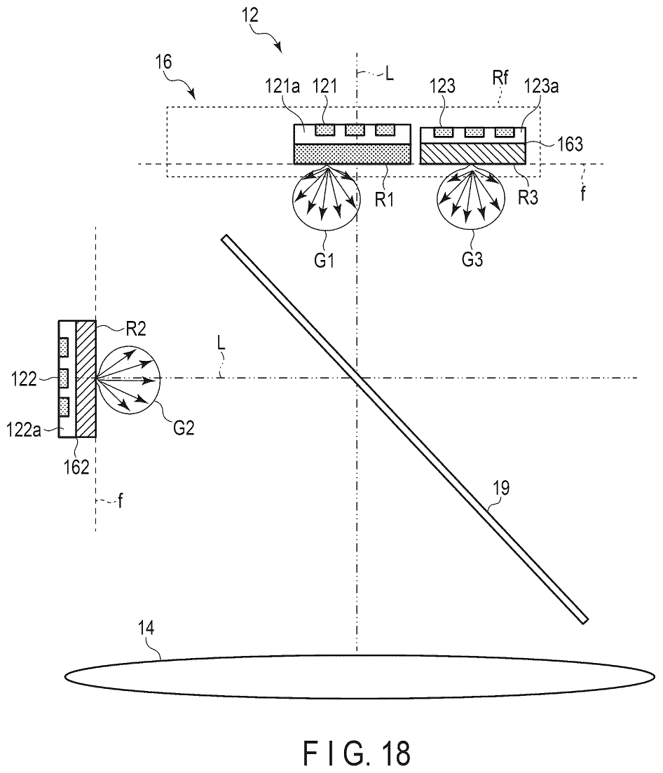

FIG. 18 illustrates a cross-sectional view of an optical apparatus 10 including an optical axis L according to the present modification. The light from a first light source 121, a second light source 122, and a third light source 123 is multiplexed by a dichroic mirror 19. The dichroic mirror 19 may be a polarizing beam splitter or a non-polarizing beam splitter. The optical element 19 is not limited to the dichroic mirror 19, and any optical element 19 can be used as far as it can combine two or more light beams. In the case of using a polarization beam splitter, the use of a polarization camera capable of sensing the polarization direction for an imaging unit 18 (See FIGS. 3, 6, and 19) makes it possible to utilize polarization information as well as color information, and acquire a lot of information on the light direction distribution at an object point. Providing two or more light sources like light source 121, 122, and 123 makes it possible to newly generate a wavelength spectrum with two separated peaks after multiplexing. Accordingly, the first wavelength spectrum and the second wavelength spectrum can be made greatly different from each other, so that it is possible to accurately distinguish colors and acquire information on the light direction distribution more accurately and quickly, for example. Alternatively, the light intensities of the two or more light sources 121, 122, and 123 can be adjusted independently and appropriately.

### Fourth Embodiment

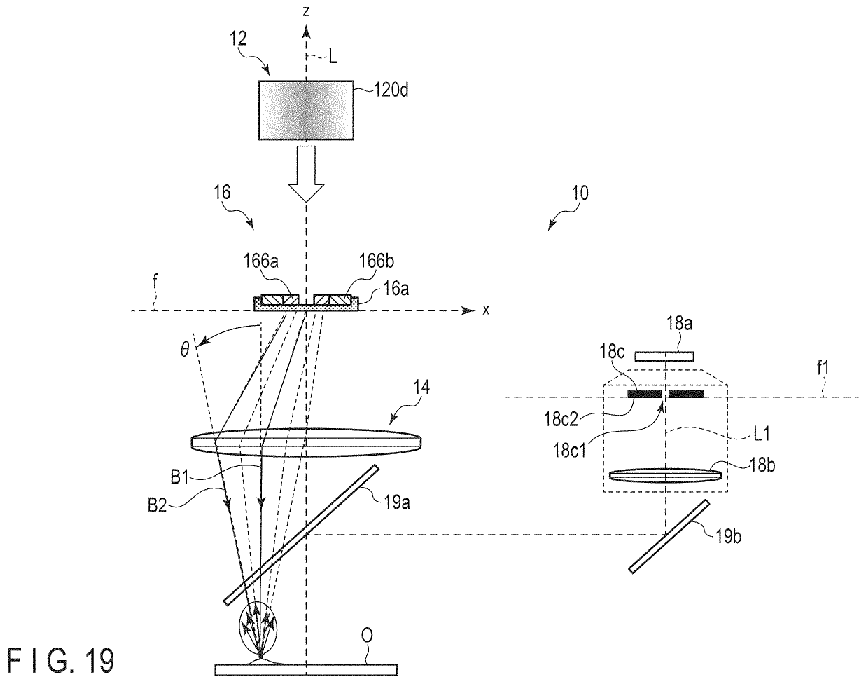

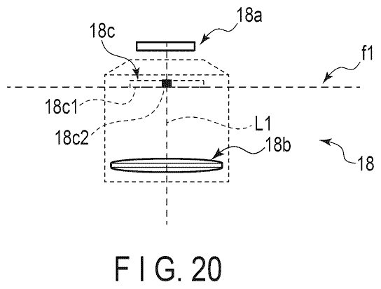

FIG. 19 is a schematic cross-sectional view of an optical inspection apparatus 1 according to the present embodiment. The optical inspection apparatus 1 according to the present embodiment includes an optical apparatus 10 and an imaging unit 18. Although not illustrated in FIG. 19, a controller 20 (See FIGS. 3 and 6) of an optical inspection system 100 is preferably connected to an image sensor 18a. The controller 20 can output color information for each pixel of an image acquired by the image sensor 18a.

The imaging unit 18 includes the image sensor 18a, an optical element for imaging 18b, and an imaging aperture 18c. The imaging aperture 18c is arranged on or near the focal plane of the image-forming optical element for imaging 18b.

A light emission portion 12 includes an LD light source 120d and emits light of a first wavelength spectrum including at least a first wavelength. The light of the first wavelength will be defined as a first light beam B1. For example, the first wavelength spectrum is blue light with a peak at a wavelength of 450 nm and a full width at half maximum of 100 nm.

A light direction selection portion 16 includes a diffuser 16a in a first light direction selection region R1, and a phosphor 166a in a second light direction selection region R2. The phosphor 166a converts light of the first wavelength into light of a second wavelength. A first light beam B1 of the first wavelength spectrum is emitted from the first light direction selection region R1, and a second light beam B2 of the second wavelength spectrum different from the light of the first wavelength spectrum is emitted from the second light direction selection region R2. That is, the light direction changer 16a emits light of the first wavelength and light of the second wavelength different from the light of the first wavelength. The second wavelength spectrum has a peak at the second wavelength. The second wavelength is 650 nm, and the second light beam B2 is red light. However, the wavelength spectrum is not limited to this, and the wavelength spectrum may be any wavelength spectrum.

The second light direction selection region R2 of the light direction selection portion 16 includes the phosphor 166b so as to sandwich the phosphor 166a between the second light direction selection region R2 and the first light direction selection region R1. The phosphor 166b converts light of the first wavelength into light of a third wavelength. Therefore, in addition to the second light beam B2 of the second wavelength spectrum, a third light beam B3 of a third wavelength spectrum is emitted from the second light direction selection region R2. The third wavelength spectrum has a peak at the third wavelength. The third wavelength is 550 nm, and the third light beam B3 is green light. However, the wavelength spectrum is not limited to this, and the wavelength spectrum may be any wavelength spectrum.

The image-forming optical element 14 is a Fresnel lens. The Fresnel lens can realize a lens of a large effective diameter even if the focal length is short as compared with other lenses. This increases the incident angle of a light beam reaching the Fresnel lens 14 from a focal plane f. Therefore, the Fresnel lens 14 has an advantageous effect of increasing the incident angle on an object surface S.

The light flux emitted from the light emission portion 12 passes through a focal plane region Rf of the image-forming optical element 14 and is applied to the object surface S. At this time, the divergence angle of the light flux is the maximum inclination angle with respect to optical axes L of the light beams B1 and B2 included in the light flux. As the range in which the light flux reaches the Fresnel lens that is the image-forming optical element 14 increases, the irradiation field F increases. That is, there is an advantageous effect that the irradiation field F is widened by the phosphors 166a and 166b provided in the second light direction selection region R2.

Hereinafter, the image-forming optical element for imaging 18b will be also referred to as an imaging optical element.

The imaging optical element 18b can form an image of light. The imaging optical element 18b may be a single lens, a set lens including a plurality of lenses, a concave mirror, a diffraction grating, a gradient index lens (GRIN lens), or the like, for example. That is, the imaging optical element 18b may be any element as long as it can form an image of light. A surface on which a set of points at infinity is imaged by the imaging optical element 18b will be defined as an imaging focal plane f1. However, the imaging focal plane f1 may be simply referred to as a focal plane. The imaging focal plane f1 and its vicinity will be referred to as an imaging focal plane region or simply as a focal plane region. The optical axis of the imaging optical element 18b is a straight line orthogonal to the imaging focal plane f1, and light emitted from a sufficiently distant point on the straight line is imaged on the straight line again. This image-forming point will be set as an imaging focal point. The imaging optical element 18b of the present embodiment is a set lens. However, the imaging optical element 18b is not limited to this.

The imaging aperture 18c is arranged in the imaging focal plane f1 of the imaging optical element 18b or in an imaging focal plane region near the imaging focal plane f1. A through-hole 18cl is provided in the vicinity of the optical axis of the imaging aperture 18c to pass light of the first wavelength, the second wavelength, and the third wavelength. On the other hand, a medium that blocks light of the first wavelength, the second wavelength, and the third wavelength is provided around the through-hole of the imaging aperture 18c. Based on geometric optics, the imaging unit 18 has a telecentric property on the object side with respect to light of the first wavelength, the second wavelength, and the third wavelength. That is, the imaging unit 18 has a telecentric property on the object side with respect to light of at least one wavelength among the light from the light source 120d.

The image sensor 18a includes pixels that can separate at least the light of the first wavelength and the light of the second wavelength among the light of the first wavelength, the light of the second wavelength, and the light of the third wavelength, for example, and independently acquire light reception signals. The image sensor 18a can distinguish and receive light of at least two wavelengths (first wavelength, second wavelength, third wavelength) as independent signals. For example, the image sensor 18a may be an area sensor or a line sensor. Alternatively, the image sensor 18a may be a single pixel. That is, the image sensor 18a may be any image sensor as long as it includes at least one color channel capable of separating at least two wavelengths and can convert light into a light reception signal. The light reception signal may be simply referred to as a signal, a signal value, or a pixel value.

Next, the operations of the optical inspection apparatus 1 according to the present embodiment will be described.

Basically, the irradiation of the object surface S with light from the optical apparatus 10 is the same as that described above in Modification 4 (FIG. 16) of the second embodiment, and thus the description thereof will be omitted as appropriate.

The standard surface of the object O is flat and smooth. Light incident on the standard surface is specularly reflected. In specular reflection, based on geometric optics, the incident angle and the reflection angle in the incident surface are equal, and the incident light beam and the reflected light beam can be associated with each other on a one-to-one basis. On the other hand, it is assumed that there are defects such as asperities, dirt, or scratches exists on the object surface S. Thus, the light incident on the defects is scattered and reflected in various directions. That is, reflected light beams are generated in various directions from one incident light beam. The direction distribution of such reflected light beams can be described by BRDF.

The image-forming optical element 14 in the optical apparatus (illumination portion) 10 irradiates the object surface S with incident light having passed through an arbitrary point on the illumination focal plane f. Based on geometric optics, the angle of the light beam passing through the image-forming optical element 14 with respect to the optical axis L is determined according to the passing point on the focal plane f. That is, all the light beams emitted from the same passing point on the illumination focal plane f have the same light beam angle on the object surface S side. Accordingly, the first light beam B1 is incident on the object surface S at an angle θ that is a first light beam angle with respect to the optical axis L. The second light beam B2 is incident on the object surface S at an angle θ that is a second light beam angle with respect to the optical axis L. The third light beam B3 is incident on the object surface S at an angle θ that is a third light beam angle with respect to the optical axis L. There is a relationship of the first light beam angle<the second light beam angle<the third light beam angle. The light of the first wavelength spectrum, the light of the second wavelength spectrum, and the light of the third wavelength spectrum have different colors. Thus, according to the optical apparatus 10, the object surface S can be irradiated with light beams at light beam angles different by color. That is, the optical apparatus 10 can irradiate the object surface S with light beams having incident angles different by color.

In the present embodiment, the object surface S is illuminated using the optical apparatus (illumination portion) 10 of the optical inspection apparatus 1, and then the object surface S is imaged using the imaging unit 18 of the optical inspection apparatus 1.

First, a case where the object surface S is a standard surface will be discussed. In this case, as illustrated in FIG. 19, the first light beam B1 is specularly reflected by the object surface S, passes through a beam splitter 19a and a mirror 19b, passes through the through-hole of the imaging aperture 18c in the focal plane f1 of the imaging optical element 18b, and is imaged by the image sensor 18a. The angle formed by reflected light of the first light beam B1 with respect to the imaging optical axis L1 will be defined as a first reflected light beam angle. The mirror 19b may be any mirror as long as it reflects light, and may be a beam splitter.

The second light beam B2 is specularly reflected by the object surface S, passes through the beam splitter 19a and the mirror 19b, and is blocked by the medium of the imaging aperture 18c of the focal plane f1 of the imaging optical element 18b. The angle formed by reflected light of the second light beam B2 with respect to the imaging optical axis L1 will be defined as a second reflected light beam angle. Similarly, the third light beam B3 is specularly reflected by the object surface S, passes through the beam splitter 19a and the mirror 19b, and is blocked by the medium of the imaging aperture 18c of the focal plane f1 of the imaging optical element 18b. The angle formed by reflected light of the third light beam B3 with respect to the imaging optical axis L1 will be defined as a third reflected light beam angle.

Accordingly, the second light beam B2 and the third light beam B3 do not reach the image sensor 18a of the imaging unit 18 and are not imaged. That is, if the object surface S is the standard surface, the image is captured only with the light of the first wavelength, and is not captured with the light of the second wavelength and the light of the third wavelength. In other words, the standard surface is imaged only with blue light, and is not imaged with red light or green light.

The image sensor 18a includes at least one color channel, and the color channel can receive light of a predetermined wavelength spectrum and convert the light into a signal. The first wavelength is included in the predetermined wavelength spectrum, and the second wavelength is not included in the predetermined wavelength spectrum.

Next, a case where there are defects on the object surface S will be discussed. In particular, it is assumed that there are defects on the surface S that the first light beam B1 and the second light beam B2 reach. The first light beam B1 is scattered by the defects on the object surface S, and the BRDF spreads. Accordingly, a part of the scattered light passes through the beam splitter 19a and the mirror 19b, passes through the through-hole of the imaging aperture 18c in the focal plane f1 of the imaging optical element 18b, and is imaged by the image sensor 18a.

On the other hand, the second light beam B2 is also scattered by the defects on the object surface S, and the BRDF spreads. Accordingly, a part of the scattered light passes through the beam splitter 19a and the mirror 19b, passes through the through-hole of the imaging aperture 18c in the focal plane f1 of the imaging optical element 18b, and is imaged by the image sensor 18a. That is, if there are defects on the object surface S, the defects are imaged by the light of the first wavelength and the light of the second wavelength. In other words, the defects are imaged with both blue light and red light.

The image sensor 18a includes at least one color channel, and the color channel can receive light of a predetermined wavelength spectrum and convert the light into a signal. The first wavelength is included in the predetermined wavelength spectrum, and the second wavelength is included in the predetermined wavelength spectrum.

Although detailed description is omitted, in the present embodiment, it is assumed that not only the first light beam B1 and the second light beam B2 but also the third light beam B3 reaches the surface S on which there are defects. Also in this case, the image sensor 18a images the defects with not only the light of the first wavelength and the light of the second wavelength but also the light of the third wavelength. In other words, the defects are imaged by blue light, red light, and green light.

The controller 20 of the optical inspection system 100 analyzes the color information of the image acquired by the image sensor 18a, so that the presence or absence of defects on the object surface S can be determined by the colors of the captured image. Therefore, the controller 20 of the optical inspection system 100 outputs the state of the surface S of the object O based on the image acquired by the image sensor 18a. On the other hand, if the imaging unit 18 does not have the imaging aperture 18c, the presence or absence of such a defect cannot be identified by color. This is because if the imaging aperture 18c is not provided, light of all colors is imaged by the image sensor 18a regardless of the presence or absence of defects on the object O. Therefore, the optical inspection apparatus 1 has an object-side telecentric property with respect to light of at least one wavelength among the light from the light source 120d, and thus, thereby having an advantageous effect of identifying the presence or absence of defects.

In the present embodiment, a through-hole is formed on the imaging optical axis L1 of the imaging aperture 18c of the imaging unit 18, and a medium is formed around the through-hole. For example, FIG. 20 illustrates a modification of the imaging unit 18. FIG. 20 does not illustrate an optical apparatus 10. Contrary to the example illustrated in FIG. 19, an imaging aperture 18c of an imaging unit 18 has a medium on an imaging optical axis L1 of the imaging unit 18 and a penetrating portion (space) around the medium. A first wavelength is not included in a predetermined wavelength spectrum, and a second wavelength is included in the predetermined wavelength spectrum. That is, if an object surface S is a standard surface, a first light beam B1 is specularly reflected by the object surface S and blocked by the medium on the imaging optical axis L1 of the imaging aperture 18c of a focal plane f1 of an imaging optical element 18b, and a second light beam B2 is specularly reflected by the object surface S, passes through the penetrating portion deviated from the imaging optical axis L1 of the imaging aperture 18c, and is imaged by an image sensor 18a. Similarly to the second light beam B2, a third light beam B3 is imaged by the image sensor 18a. Therefore, by configuring the imaging aperture 18c as in the example illustrated in FIG. 19 or the example illustrated in FIG. 20, if the object surface S is a standard surface, for example, light of a desired wavelength can be selectively received by the image sensor 18a.

On the other hand, when the object surface S in an irradiation field F1 has minute asperities or the like, the light is scattered by the minute asperities and reflected in various directions. Such a reflection characteristic can be described by a bidirectional reflectance distribution function (BRDF) representing the intensity of light for each reflection direction. For example, a case where the object surface S has minute asperities will be discussed. The first light beam B1 passing through a first light direction selection region R1 is scattered by the minute asperities into various light beam groups, and some of the light beams are directed toward the observer. The scattered light beam group also has the same wavelength spectrum as the first light beam B1. Therefore, each light beam of the scattered light beam group is also treated as the first light beam B1. In this way, when the object surface S has minute asperities, the first light beam B1 is observed by the observer. At the same time, the second light beam B2 passing through a second light direction selection region R2 is also scattered by minute asperities and directed toward the observer. Therefore, when the object surface S has minute asperities, the second light beam B2 is also observed by the observer. The second light beam B2 passing through a fourth light direction selection region R4 is also scattered by minute asperities and directed toward the observer. Therefore, when the object surface S has minute asperities, the second light beam B2 is also observed by the observer. Accordingly, the observer observes not only the first light beam B1 but also the second light beam B2.

As described above, if the object surface S is a smooth surface, the first light beam B1 passing through the first light direction selection region R1 is not observed by the observer. Similarly, the first light beam B1 passing through a third light direction selection region R3 is not observed by the observer. That is, the smooth surface cannot be observed by the first light beam B1. However, the smooth surface can be observed by the second light beam B2 passing through the second light direction selection region R2 and the fourth light direction selection region R4.

However, if the object surface S has minute asperities, not only the first light beam B1 passing through the first light direction selection region R1 but also the second light beam B2 passing through the second light direction selection region R2 and the second light beam B2 passing through the fourth light direction selection region R4 are observed. That is, the minute asperities can be observed not only by the first light beam B1 but also by the second light beam B2.

According to the present embodiment, there are provided the optical apparatus 10, an optical inspection apparatus 1 including the optical apparatus 10, and an optical inspection system 100 including the optical inspection apparatus 1, capable of illuminating an object O with light beams B2 of which the direction is changed from the direction of at least some of light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2. In addition, according to the present embodiment, there is provided an optical inspection method by which the object O can be illuminated with the light beams B2 of which the direction is changed from the direction of at least some of the light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2.

### Fifth Embodiment

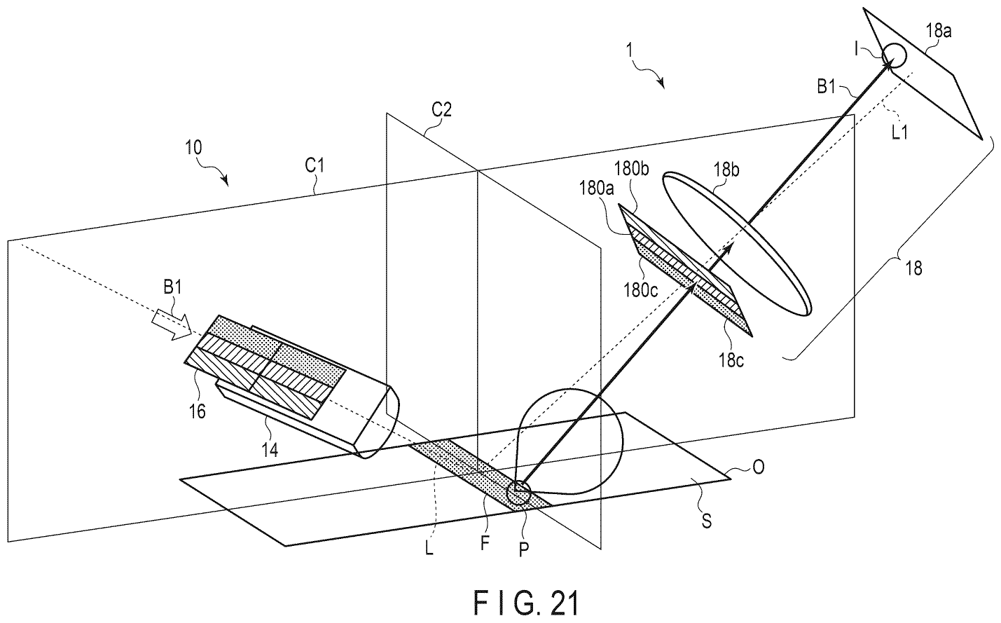

Hereinafter, an optical inspection apparatus 1 according to the present embodiment will be described in detail with reference to FIG. 21.

FIG. 21 is a perspective view of the present embodiment. The optical inspection apparatus 1 according to the present embodiment includes an illumination portion (optical apparatus) 10 and an imaging unit 18. However, FIG. 21 does not illustrate a light emission portion 12 of the illumination portion 10. A first cross section C1 includes an optical axis L of an image-forming optical element 14 of the illumination portion 10 and an imaging optical axis L1. A second cross section C2 is orthogonal to the first cross section C1. The basic configuration is the same as that of the fourth embodiment. The differences will be described below.

Hereinafter, the image-forming optical element 14 of the illumination portion 10 will be referred to as an illumination optical element.

The illumination optical element 14 has translational symmetry in a direction orthogonal to the first cross section C1. This direction will be defined as a longitudinal direction of the illumination optical element 14. The illumination optical element 14 is a cylindrical lens, for example. An illumination optical axis L of the cylindrical lens 14 is on the first cross section C1.

The light emission portion 12 includes a DLP projector 120c (see FIG. 16) as a projection portion, to project an image onto a focal plane region Rf of the illumination optical element 14. Accordingly, an object surface S is illuminated, and an irradiation field F is formed. When being projected onto the second cross section C2, the illumination light becomes divergent light.

The imaging unit 18 includes an imaging optical element 18b, an imaging aperture 18c, and an imaging element 18a. The imaging element 18a is an image sensor and is a line sensor. However, the imaging element 18a is not limited to this, and the imaging element 18a may be an area sensor. The longitudinal direction of the line sensor 18a coincides with the longitudinal direction of the illumination optical element 14.

The imaging aperture 18c includes a wavelength selection portion. The wavelength selection portion 18c has at least two (here, three) wavelength selection regions 180a, 180b, and 180c. The wavelength selection regions 180a, 180b, and 180c have translational symmetry in a direction orthogonal to the first cross section C1. This direction will be defined as a longitudinal direction of the wavelength selection regions 180a, 180b, and 180c. The wavelength selection portion 18c includes a plurality of wavelength selection regions 180a, 180b, and 180c arranged in a stripe shape. On the wavelength selection regions 180a, 180b, and 180c, a direction in which the wavelength selection regions 180a, 180b, and 180c change is set as an arrangement direction. This arrangement direction is parallel to the first cross section C1. That is, the arrangement direction of the wavelength selection regions 180a, 180b, and 180c is orthogonal to the longitudinal direction of the line sensor 18a.

An object O is conveyed in a direction orthogonal to the longitudinal direction of the line sensor 18a. The line sensor 18a can acquire a two-dimensional image of the object O by continuously imaging the object O conveyed in this manner.

A light flux emitted from the projector 120c passes through a light direction selection portion 16 and irradiates the object surface S to form the irradiation field F. If there are minute defects at a first object point P, a BRDF spreads, and some light beams pass through the imaging aperture 18c to form an image of the first object point P on the line sensor 18a. On the other hand, if the first object point P is on a standard surface, a first light beam B1 of a first wavelength is specularly reflected on the standard surface. At this time, by appropriately forming a projection image from the projector 120c, the first light beam B1 can reach the center of the imaging aperture 18c of the imaging unit 18. That is, the first light beam B1 can reach the region including the imaging optical axis L1. The wavelength selection region 180a arranged at the center of the imaging aperture 18c is formed so as to block light of the first wavelength. Accordingly, if there are no minute defects at the first object point P, the first object point P is not imaged by the light of the first wavelength.

On the other hand, if there are minute defects at the first object point P, the first object point P is imaged by the light of the first wavelength passing through the wavelength selection regions 180b and 180c. This has an advantageous effect that the presence or absence of minute defects can be identified. Furthermore, information on the spread of a light direction distribution (that is, BRDF) at the object point P can be obtained.

If the first object point P is on the standard surface, a second light beam of a second wavelength different from the first wavelength is also specularly reflected on the standard surface in the same manner. At this time, appropriately forming a projection image by the projector 120c allows the reflection direction of the second light beam B2 to coincide with the reflection direction of the first light beam B1. Accordingly, the light beam of the second wavelength reaches the center of the imaging aperture 18c of the imaging unit 18. That is, the light beam of the second wavelength reaches the wavelength selection region 180a including the imaging optical axis L1 on the imaging aperture 18c. The wavelength selection region 180a arranged at the center of the imaging aperture 18c is formed to transmit light of the second wavelength. Based on geometric optics, the imaging unit 18 has a telecentric property on the object side with respect to light of the second wavelength. That is, the imaging unit 18 has a telecentric property on the object side with respect to light of at least one wavelength among the light from the light source 120c. This has an advantageous effect that a telecentric image in a bright field can be acquired by the second wavelength. That is, the detailed information on object surface S can be acquired together with the image captured using the first light beam B1.

A light beam projected onto the first cross section C1 will be discussed. Since the distribution of a first BRDF spreads, light reaches the wavelength selection regions 180b and 180c, although it would not reach in the case of the standard surface, and passes through the wavelength selection regions 180b and 180c. It can be seen here that the reflected light reaches the wavelength selection region 180b or 180c in the imaging aperture 18c according to the direction of the reflected light. However, the light beam having reached the outside of the range of the imaging aperture 18c, which is further outside the medium of the imaging aperture 18c, is not incident on the imaging optical element 18b and is not imaged. That is, the range of light beam directions in which imaging is possible is limited by the imaging aperture 18c. On the other hand, a light beam projected onto the second cross section C2 will be considered. Since the light from the illumination portion 10 is diffused light, it can be seen that the angle of view in the imaging unit 18 becomes wider according to the divergence angle of the diffused light. In addition, since the wavelength selection regions 180a, 180b, and 180c form a stripe shape, it can be seen that the color of the light beam does not depend on the angle of view. Making the longitudinal direction of the stripe sufficiently long has an advantageous effect that the angle of view in the longitudinal direction of the line sensor 18a can be widely and effectively used. By arranging the wavelength selection portion 18c in front of the line sensor 18a and the imaging optical element 18b of the imaging unit 18, the optical system including the line sensor 18a, the imaging optical element 18b, and the wavelength selection portion 18c can be easily assembled to any imaging unit 18.

According to the present embodiment, information on the spread of a light direction distribution at the object point P can be obtained. There is an advantageous effect that the imaging field of view of the imaging unit 18 can be made wider as the line sensor 18a is lengthened in the longitudinal direction. This makes it possible to inspect the property or shape of the object surface S.

According to the present embodiment, there are provided the optical apparatus 10, an optical inspection apparatus 1 including the optical apparatus 10, and an optical inspection system 100 including the optical inspection apparatus 1, capable of illuminating an object O with light beams B2 of which the direction is changed from the direction of at least some of light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2. In addition, according to the present embodiment, there is provided an optical inspection method by which the object O can be illuminated with the light beams B2 of which the direction is changed from the direction of at least some of the light beams B1 emitted from the light emission portion 12. At least some of the light beams B1 emitted from the light emission portion 12 can be emitted as the light beams B2 having optical characteristics different from those of the light beams B1 according to the first light direction selection region R1 or the second light direction selection region R2.

According to at least one of these embodiments, it is possible to provide the optical apparatus 10, the optical inspection system 100 including the optical apparatus 10, and the optical inspection method, capable of illuminating the object O with light beams of which the direction is changed from the direction of at least some of the light beams B1 emitted from the light emission portion 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical apparatus comprising:
a light emission portion;
a light direction selection portion; and
an image-forming optical element,
wherein:
the light emission portion is configured to emit a first light beam of a first wavelength spectrum including a first wavelength,
the light direction selection portion includes a first light direction selection region and a second light direction selection region on or near a focal plane of the image-forming optical element, and
the first light beam incident on the first light direction selection region or the second light direction selection region is emitted as a light beam having a different optical characteristic according to the regions, and at least one of the regions includes a light direction changer that is configured to change a direction of the incident light beam to a different direction and emits the light beam.

2. The optical apparatus according to claim 1, wherein
the light direction selection portion includes a diffuser that is arranged in at least one of the first light direction selection region and the second light direction selection region,
the light direction selection portion generating at least two light beams of a direction different from the direction of the incident light, and diffusing the light.

3. The optical apparatus according to claim 2, wherein
the diffuser is a wavelength conversion diffuser that is configured to convert light of the first wavelength into light of a second wavelength different from the first wavelength,
the wavelength conversion diffuser is arranged in the second light direction selection region, and
light of a second wavelength spectrum different from light of the first wavelength spectrum and including the second wavelength is emitted from the second light direction selection region.

4. The optical apparatus according to claim 1, wherein
the light direction selection portion includes a phosphor plate provided with a through-hole, and
a region provided with the through-hole is the first light direction selection region, and a region provided with the plate of the phosphor is the second light direction selection region.

5. The optical apparatus according to claim 1, wherein
the light direction selection portion includes a light attenuator that is arranged that is configured to attenuate light of the first wavelength in one of the first light direction selection region and the second light direction selection region.

6. The optical apparatus according to claim 1, wherein
the image-forming optical element is formed of an array of a first image-forming optical element and a second image-forming optical element,
the light direction selection portion includes a third light direction selection region and a fourth light direction selection region similar to the first light direction selection region and the second light direction selection region,
the first light direction selection region and the second light direction selection region are arranged so as to face the first image-forming optical element, and
the third light direction selection region and the fourth light direction selection region are arranged so as to face the second image-forming optical element.

7. An optical inspection apparatus comprising:
the optical apparatus according to claim 1; and
an imaging unit configured to capture an image illuminated by the optical apparatus,
wherein:
the imaging unit includes:
an image sensor;
an image-forming optical element for imaging; and
an imaging aperture.

8. The optical inspection apparatus according to claim 7, wherein:
the light direction changer is configured to emit light of the first wavelength and light of a second wavelength different from the light of the first wavelength,
the image sensor includes at least one color channel, and the color channel is configured to receive light of a predetermined wavelength spectrum and converting the light into a signal,
the first wavelength is included in the predetermined wavelength spectrum, and
the second wavelength is not included in the predetermined wavelength spectrum.

9. The optical inspection apparatus according to claim 7, wherein:
the light direction changer is configured to emit light of the first wavelength and light of a second wavelength different from the light of the first wavelength,
the image sensor includes at least one color channel, and the color channel is configured to receive light of a predetermined wavelength spectrum and converting the light into a signal,
the first wavelength is included in the predetermined wavelength spectrum, and
the second wavelength is included in the predetermined wavelength spectrum.

10. The optical inspection apparatus according to claim 7, wherein
the light direction changer is configured to emit light of the first wavelength and light of a second wavelength different from the light of the first wavelength,
the image sensor includes at least one color channel, and the color channel is configured to receive light of a predetermined wavelength spectrum and converting the light into a signal,
the first wavelength is not included in the predetermined wavelength spectrum, and
the second wavelength is included in the predetermined wavelength spectrum.

11. The optical inspection apparatus according to claim 7, wherein
the optical apparatus is configured to illuminate an object, and
the image sensor includes at least two different color channels that are configured to differentially receive light of the first wavelength and light of the second wavelength as independent signals.

12. An optical inspection system comprising:
the optical inspection apparatus according to claim 7; and
a controller configured to output a state of a surface of an object based on an image acquired by the image sensor.

13. An optical inspection method comprising:
emitting a first light beam of a first wavelength spectrum including a first wavelength toward an image-forming optical element;
changing the first light beam incident on a first light direction selection region or a second light direction selection region of a light direction selection portion provided in a focal plane or a focal plane region near the focal plane of the image-forming optical element to a light beam having a different optical characteristic according to the regions; and
emitting the light beam in a direction different from an incident direction of the first light beam to illuminate an object.

14. The optical inspection method according to claim 13, further comprising acquiring information about a surface of the object by light from the object generated by illuminating the object.
